(19) United States
(12) Patent Application Publication
(10) Pub. No.: US 2023/0328545 A1
(43) Pub. Date: Oct. 12, 2023

(54) WAVEFORM AGNOSTIC LEARNING-ENHANCED DECISION ENGINE FOR ANY RADIO

(71) Applicant: A10 Systems LLC, Chelmsford, MA (US)

(72) Inventors: Apurva N. Mody, Chelmsford, MA (US); Bryan Crompton, Lowell, MA (US); Dukhyun Kim, Keller, TX (US)

(73) Assignee: A10 Systems LLC, Chelmsford, MA (US)

(21) Appl. No.: 18/069,114

(22) Filed: Dec. 20, 2022

Related U.S. Application Data
(60) Provisional application No. 63/291,856, filed on Dec. 20, 2021.

(51) Int. Cl. H04W 24/02; G06N 3/08

(52) U.S. Cl. CPC H04W 24/02; G06N 3/08

(57) ABSTRACT

One or more aspects of the present disclosure are directed to a software-based solution that can classify interference signals in real-time affecting a radio equipment and provide/implement an interference mitigations scheme to combat the interference signal and restore communication system of the radio equipment. In one aspect, a radio equipment includes memory having computer-readable instructions stored therein and one or more processors. The one or more processors are configured to execute the computer-readable instructions to receive at least one interference signal via an antenna of the radio; determine one or more layers characteristics of one or network layers used for transmission of signals for the radio; classify the interference signal using one or more features in the interference signal and the one or more layers characteristics; and determine an interference mitigation scheme for countering the interference signal.

### CROSS REFERENCE TO RELATED APPLICATIONS

The present application claims priority to Provisional Patent Application No. 63/291,856, filed Dec. 20, 2021, and entitled “WAVEFORM AGNOSTIC LEARNING-ENHANCED DECISION ENGINE FOR ANY RADIO,” the disclosure of which is hereby incorporated by reference herein in its entirety for all purposes.

### STATEMENT REGARDING FEDERALLY SPONSORED RESEARCH OR DEVELOPMENT

This application was made pursuant to U.S. Government Contracts No. W56KGU-20-C-0063 and W56KGU-22-C-0003. The U.S. Government has certain rights in this invention.

### TECHNICAL FIELD

The subject matter of this disclosure generally relates to the field of wireless network operations and, more particularly, to interference classification and mitigation for radio access network equipment.

### BACKGROUND

Wireless broadband represents a critical component of economic growth, job creation, and global competitiveness because consumers are increasingly using wireless broadband services to assist them in their everyday lives. Demand for wireless broadband services and the network capacity associated with those services is surging, resulting in the development of a variety of systems and architectures that can meet this demand including, but not limited to, mixed topologies of heterogeneous multi-vendor networks.

The advent of Software Defined Radios (SDRs) has provided new avenues for adversaries to create Electronic Attack (EA) techniques that are developed and deployed at a rate outpacing waveform development. New EA techniques are not just limited to the Physical Layer (PHY). They can span the Medium Access Control (MAC) and also the Network Layer (NET).

### SUMMARY

One or more aspects of the present disclosure are directed to a software-based solution, Waveform Agnostic learning-enhanced Decision Engine for any Radio (WADER), that can classify interference signals in real-time affecting a radio equipment and provide/implement an interference mitigations scheme to combat the interference signal and restore communication system of the radio equipment.

In one aspect, a radio equipment includes memory having computer-readable instructions stored therein and one or more processors. The one or more processors are configured to execute the computer-readable instructions to receive at least one interference signal via an antenna of the radio; determine one or more layers characteristics of one or network layers used for transmission of signals for the radio; classify the interference signal using one or more features in the interference signal and the one or more layers characteristics; and determine an interference mitigation scheme for countering the interference signal.

In another aspect, the one or more processors are further configured to determine a feature matrix based on a combination of the one or more features and the one or more layers characteristics, and classify the interference signal using the feature matrix.

In another aspect, the one or more processors are configured to classify the interference signal using a trained neural network, the trained neural network being configured to receive the feature matrix as an input and provide a classification of the interference signal as an output.

In another aspect, one or more processors are configured to determine the interference mitigation scheme using a trained neural network, the trained neural network being configured to receive the classified interference signal as an input and provide as output the interference mitigation scheme.

In another aspect, the one or more processors are further configured to implement the interference mitigation scheme by modifying at least one parameter associated with signal transmission using the radio.

In another aspect, the at least one parameter is a configuration of one or more network layers.

In another aspect, the one or more network layers including a physical layer, a MAC layer and a network layer of a modem of the radio equipment.

In one aspect, one or more non-transitory computer-readable media include computer-readable instructions, which when executed by one or more processors of a radio equipment, cause the radio equipment to receive at least one interference signal via an antenna of the radio; determine one or more layers characteristics of one or network layers used for transmission of signals for the radio; classify the interference signal using one or more features in the interference signal and the one or more layers characteristics; and determine an interference mitigation scheme for countering the interference signal.

In another aspect, the execution of the compute-readable instructions further causes the radio equipment to determine a feature matrix based on a combination of the one or more features and the one or more layers characteristics; and classify the interference signal using the feature matrix.

In another aspect, the execution of the compute-readable instructions further cause the radio equipment to classify the interference signal using a trained neural network, the trained neural network being configured to receive the feature matrix as an input and provide a classification of the interference signal as an output.

In another aspect, the execution of the compute-readable instructions further causes the radio equipment to determine the interference mitigation scheme using a trained neural network, the trained neural network being configured to receive the classified interference signal as an input and provide as output the interference mitigation scheme.

In another aspect, the execution of the compute-readable instructions further causes the radio equipment to implement the interference mitigation scheme by modifying at least one parameter associated with signal transmission using the radio.

In another aspect, the at least one parameter is a configuration of one or more network layers.

In another aspect, the one or more network layers including a physical layer, a MAC layer and a network layer of a modem of the radio equipment.

In one aspect, a method includes receiving, at a controller of a radio equipment, at least one interference signal via an antenna of the radio; determining, by the controller, one or more layers characteristics of one or network layers used for transmission of signals for the radio; classifying, by the controller, the interference signal using one or more features in the interference signal and the one or more layers characteristics; and determining, by the controller, an interference mitigation scheme for countering the interference signal.

In another aspect, the method further includes determining a feature matrix based on a combination of the one or more features and the one or more layers characteristics, and classifying the interference signal using the feature matrix.

In another aspect, the interference signal is classified using a trained neural network, the trained neural network being configured to receive the feature matrix as an input and provide a classification of the interference signal as an output.

In another aspect, the interference mitigation scheme is determined using a trained neural network, the trained neural network being configured to receive the classified interference signal as an input and provide as output the interference mitigation scheme.

In another aspect, the interference mitigation scheme is implemented by modifying at least one parameter associated with signal transmission using the radio.

In another aspect, the at least one parameter is a configuration of one or more network layers.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example architecture of a WADER system according to some aspects of the present disclosure;

FIG. 2 illustrates an example architecture of CLS engine of FIG. 1 according to some aspects of the present disclosure;

FIGS. 3A-B illustrates examples of feature matrices according to some aspects of the present disclosure;

FIG. 4 illustrates an example radio system in which WADER architecture of FIGS. 1 and 2 can be utilized according to some aspects of the present disclosure;

FIG. 5 illustrates an example architecture of WALDEN engine of FIG. 1 according to some aspects of the present disclosure;

FIG. 6 illustrates an example neural network that can be trained to perform interference signal detection and classification, and/or interference mitigation scheme according to some aspects of the present disclosure;

FIG. 7 illustrates an example process of classifying and mitigating an interference signal according to some aspects of the present disclosure;

FIGS. 8A-X illustrates example outputs of simulation tests for interference detection, classification, and mitigation according to some aspects of the present disclosure;

FIG. 9 illustrates an example of neural network training according to some aspects of the present disclosure;

FIGS. 10A-G illustrate examples of channel interference according to some aspects of the present disclosure

FIG. 11 illustrates an example network device according to some aspects of the present disclosure; and

FIG. 12 shows an example of a computing system according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The following is a table of acronyms that may be used/referenced throughout the present disclosure.

Acronyms

| | |
|---|---|
| AGI | Analytical Graphics, Inc |
| API | Application Programming Interface |
| APP | Application or Application Layer |
| CCC | Common Control Channel |
| CCSDS | Consultative Committee for Space Data Systems |
| CDE | CLAIRE Decision Engine |
| CLAIRE | Cross Layer Spectrum Aware Cognitive Control Plane and |
| | Intelligent Routing Engine |
| CLS | Cross Layer Sensing |
| Comms | Communications |
| DARPA | Defense Advanced Research Projects Agency |
| DBB | Differential Buffer Backlog |
| DCNN | Deep Convolutional Neural Network |
| DDTRX | Direct Digital Transceiver |
| DSA | Dynamic Spectrum Access |
| EVA | Extravehicular Activity |
| FIFO | First in, First Out |
| GUI | Graphical User Interface |
| HDTN | High Speed Delay Tolerant Network |
| HTTP | Hypertext Transfer Protocol |
| ICD | Interface Control Document |
| INSPiRE | Intelligent Network Slicing & Policy-based Routing Engine |
| JSON | JavaScript Object Notification |
| JSON-RPC | JSON Remote Procedure Call |
| MAC | Medium Access Control Layer |
| MB | Moon Base |
| MIMO | Multiple-Input Multiple-Output |
| NESS | Network Slicing Engine System |
| NET | Network Layer |
| NFV | Network Function Virtualization |
| OFDM | Orthogonal Frequency-Division Multiplexing |
| OODA | Observe Orient Decide and Act |
| OS | Operating System |
| OWL | Web Ontology Language |
| PE | Policy Engine |
| PF | Packet Forwarding |
| PHY | Physical Layer |
| PNT | Positioning, Navigation, and Timing |
| QoE | Quality of Experience |
| RAN | Radio Area Network |
| RDF | Resource Description Framework |
| RF | Radio Frequency |
| SADR | Spectrum and Delay Aware Routing |
| SCaN | Space Communications and Navigation |
| SISO | Single-Input Single-Output |
| SOA | Service Oriented Architecture |
| SON | Self-Organizing Network |
| SPARQL | SPARQL Protocol and RDF Query Language |
| STK | Systems Tool Kit |
| TCP | Transmission Control Protocol |
| UHF | Ultra-High Frequency |
| W3C | World Wide Web Consortium |
| XML | Extensible Markup Language |

As noted above, the advent of Software Defined Radios (SDRs) has provided new avenues for adversaries to create Electronic Attack (EA) techniques that are developed and deployed at a rate outpacing waveform development. New EA techniques are not just limited to the Physical Layer (PHY). They can span the Medium Access Control (MAC) and also the Network Layer (NET). Most modern-day waveforms consist of Synchronization Signals (SS) in form of preambles and pilots, Control Fields (CF) and User Fields (UF). An adversary may use simple traditional EA technique such as Barrage Interference (BI). BI does not discriminate between different areas of signals and sends equal energy across an entire time-frequency (T-F) Domain. This is effective, but it is likely to result in tremendous energy consumption for the adversary. Instead, the adversary could target the SS or CF. The Adversary would then have to cognitively identify which fields are SS and CF and then target only those fields. Such an attack, can potentially result in much less energy consumption for the adversary and have devastating impact on the Blue Force Communications (Comms).

Transmission and communication systems are likely to encounter adversary signals in the increasingly contested and congested Anti-Access Area Denial (A2AD) scenarios. The adversary signal may be hiding anywhere in the spectrum. It may be at High Frequency (HF) and hence difficult to geolocate or jam. It may be an underlay to some high-power broadcast signal and/or it may be a new Low Probability of Detection (LPD) mode that has never been seen before and is difficult to detect using ordinary EW Receivers. It may be an LPD, Low Probability of Intercept (LPI) and/or also Low Probability of Exploitation (LPX) signal. It could be an adversary EA signal that is interfering with Blue Comms or it may be associated with a Passive SIGINT or an Electronic Support Measure (ESM) System that needs to be disabled to enable the Blue Ingress missions.

To address these deficiencies, the present disclosure describes an approach that may be referred to as Waveform Agnostic learning-enhanced Decision Engine for any Radio (WADER). WADER can meet the future needs of communication systems to counter sophisticated adversarial Electronic Warfare/Electronic Attacks (EW/EA) and restore the Comms performance. While traditional anti-jam techniques such as TRANSEC driven Frequency Hopped Spread Spectrum (FHSS) or Direct Signal Spread Spectrum (DSSS) may work against some adversaries, SDRs have provided new avenues to the adversaries to create EA techniques that are being developed and deployed at a rate outpacing waveform development.

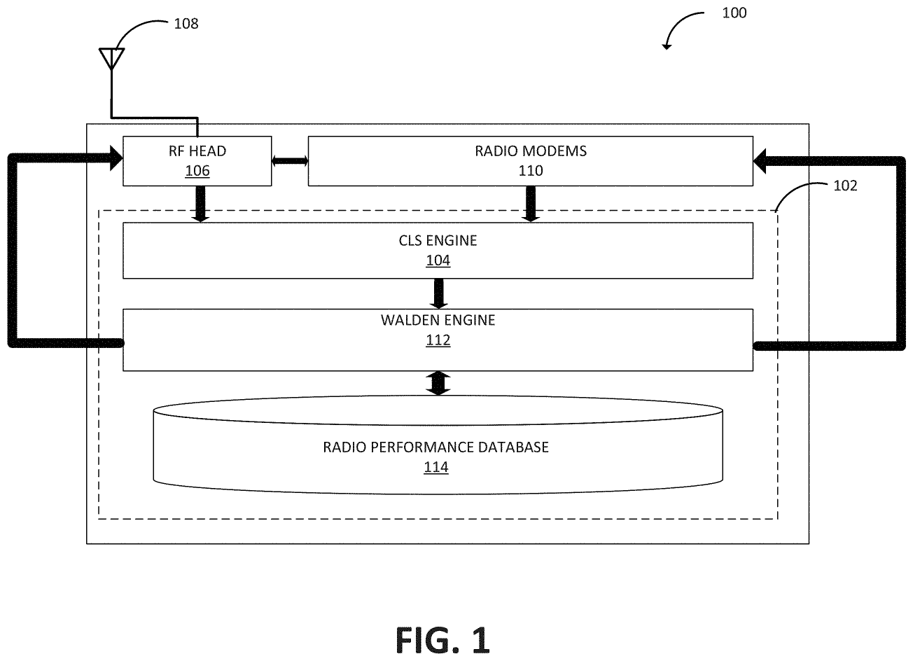

FIG. 1 illustrates an example architecture of a WADER system according to some aspects of the present disclosure.

WADER Architecture can apply to any radio equipment or any device having a radio capable of transmitting and/or receiving information using any waveform to make it more robust and resilient.

WADER architecture 100 can include a deep learning component 102. Deep learning component 102 can include Cross Layer Sensing (CLS) engine 104 which can receive raw I/Q samples from RF Module 106 when signals are received at RF module (RF head) 106 via antennas 108. CLS engine 104 may also interface with PHY, MAC, and NET layers of radio modems 110 and receive corresponding radio statistics via the Management Information Bases (MIB). RD module 106 may be communicatively coupled to radio modem(s) 110 (e.g., a bi-directional connection). In another example, while RF modules 106 may be dedicated to modems 110, a separate RF module similar to RF module 106 may be present and dedicated to WALDEN engine 112).

The PHY, MAC, and/or NET features can include radio performance measurements such as Received Signal Strength Indicator (RSSI), Carrier to Interference plus Noise Ratio (CINR), Error Vector Magnitude (EVM), Bit Error Rate (BER), PER, Modulation and Coding Settings among others.

CLS engine 104 can process the RF samples to turn them into features (e.g., Cyclostationary Statistics). CLS engine 104 can then provide the RF samples and radio statistics to WADER learning-enhanced Decision Engine (WALDEN) engine 112. Using the features provided by CLS engine 104 and radio performance measurements received from radio performance database 114, WALDEN engine 112 can detect and characterize the interference that is being encountered using techniques such as Deep Convolutional Neural Networks (DCNN). WALDEN component 112 can also use available and/or to be developed machine learning techniques over short and long-term along with game theoretic decision making to determine a strategy and technique to mitigate the interference signal(s) and restore the performance of communication system(s) in which WADER architecture 100 is utilized. The classified interference and/or mitigation strategies may then be provided as input to radio modems 110 and/or RF module 106.

As noted above, the methodology for correctly characterizing interfering signals and EAs, relies in part on cross layer sensing. Wireless networks can be vulnerable to a plethora of security threats, different types of interference, and attacks, which may be separated into Traditional and Smart or Cognitive. Traditional techniques consist of attacks such as Barrage, Chirps, FMbyNoise, Two Tones, Multiple Tones, Follower, Co-channel Interference and Direct RF Memory (DRFM). Smart or Cognitive techniques consist of Synch Sequence (SS) Attack, Pilot Field (PF) Attack, Control Field (CF) Attack, Specific User (SU) Attack, Spoofing and DSA Honeypot.

Next-generation cross-layer attacks can be stealthily and can significantly compromise the nodes. Since cross-layer attacks are stealthy, dynamic and unpredictable in nature, novel security techniques are needed. Since models of the environment and attacker's behavior may be hard to obtain in practical scenarios, machine learning techniques can aid in tackling cross-layer attacks, which will be further described below.

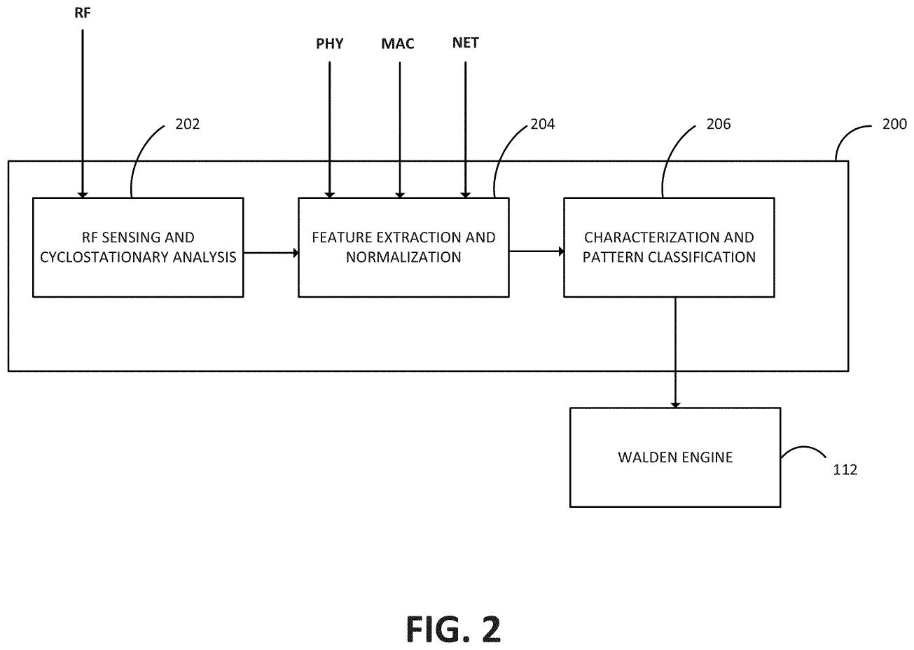

FIG. 2 illustrates an example architecture of CLS engine of FIG. 1 according to some aspects of the present disclosure.

CLS engine 200 (which can be the same as CLS engine 104 of FIG. 1), can include an RF sensing and Cyclostationary analysis component 202, a feature extraction and normalization component 204, and classification component 206.

Assuming all signals seen for the first time are unknown, RF sensing and Cyclostationary analysis component 202 can identify the dominant features of the received RF signals which may then be stored in a database (not shown) as templates for future correlation with any new signal that is observed. In one example, RF sensing and Cyclostationary analysis component 202 can determine the feature using Energy Detection (ED) in the form of PSD Processing. Signal processing techniques used can include any other known or to be developed technique.

Once the dominant features are identified (and/or the feature matrix is created), RF sensing and Cyclostationary analysis component 202 can feed the features into feature extraction and normalization component 204 where they are combined with radio statistics from PHY, MAC, and NET layers as described above with reference to FIG. 1. The features can also be normalized.

To simulate cross-layer statistics, PHY and MAC layer models may be simulated where the PHY is based on Gaussian Minimum Shift Keying (GMSK) which is a modulation format that is used by many radios. The MAC model may follow Time Division Multiple Access (TDMA) with Time Division Duplex (TDD) protocol, which is also used by many radios. The MAC can consist of a Forward Frame Synchronization Sequence (F-SYNC), a Forward Frame Payload, a small gap, a Reverse Frame Synchronization Sequence (R-SYNC), a Reverse Frame Payload, and another small gap.

In some examples, feature extraction and normalization component 204 may combine the features with radio statistics (received via MIBs as described above with reference to FIG. 1) to create a feature matrix that may then be input into a classifier such as classification component 206

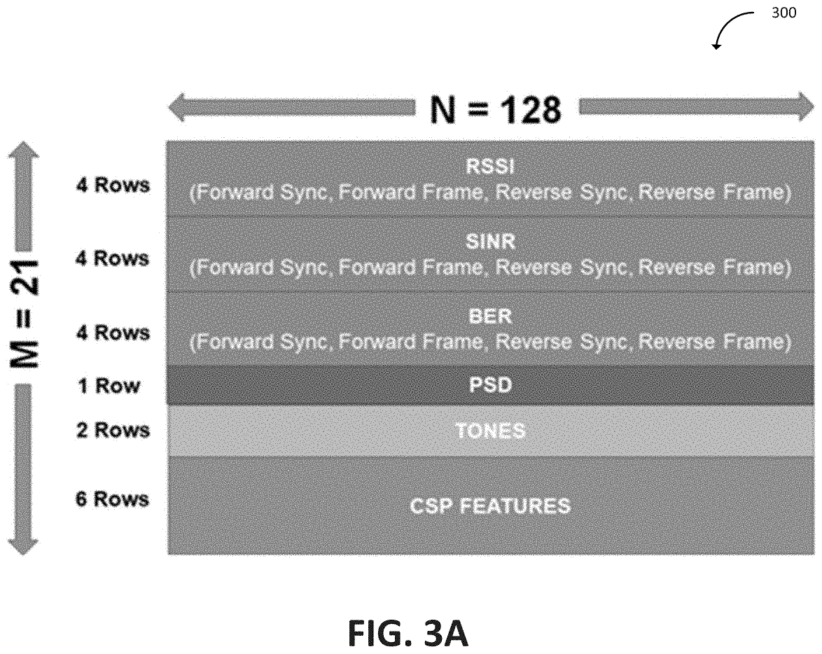

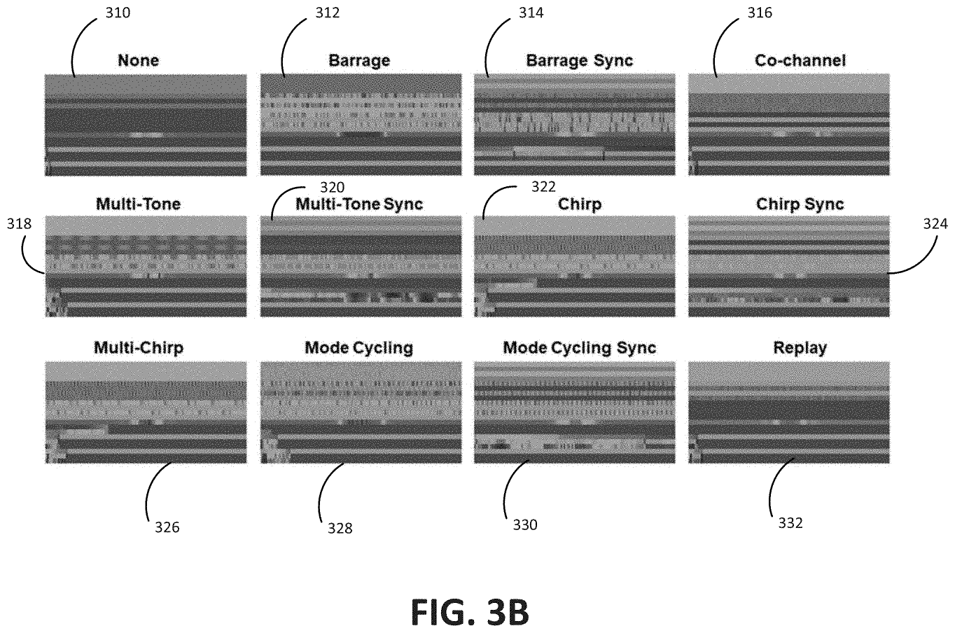

FIGS. 3A-B illustrate examples of feature matrices according to some aspects of the present disclosure. Feature matrix 300 of FIG. 3A can be a two-dimensional matrix with each row corresponding to a given extracted characteristic (e.g., RSSI, SINR, BER, etc.).

Once the features are extracted and normalized, classification component 206 can identify and classify interferences. In one example, an interference can be identified from among 12 different classes of interreferences. However, the present disclosure is not limited thereto and any other type of known or to be developed interference can be detected.

Non-limiting examples of interference classes include 1. No interference, 2. Barrage Interference, 3. Tone Interference, 4. Chirp Interference, 5. Multi-Chirp Interference, 6. Mode Cycling Interference, 7. Barrage Sync Interference, 8. Tone Sync Interference, 9. Chirp Sync Interference, 10. Mode-Cycling SYNC, 11. Replay Interference, and 12. Cochannel Interference.

FIG. 3B illustrates example feature matrices 310, 312, 314, 316, 318, 320, 322, 324, 326, 328, 330, and 332, each of which is associated with a different interference class such as interference classes enumerated above.

Identification and classification of interferences may be as follows.

Detecting and classifying forms of interference can include feeding the received features (e.g., in the form of feature matrix 300 of FIG. 3) into a DCNN used by classification component 206. The set of features can be divided into cross layer sensing features including, but not limited to, BER, RSSI, Signal to Interference plus Noise Ratio (SINR) values, and Cyclostationary Signal Processing (CSP) features which include the Power Spectral Density (PSD), detected tones, and spectral correlation function, both conjugate and non-conjugate, and spectral coherence values, both conjugate and non-conjugate, etc.

In one example, the normalized features are fed directly into the deep neural networks. Using DCNN that is trained to receive the normalized features and provide a classification for the interference as output a classification for the detected interference signal. The output of classification component 206 may then be fed into WALDEN engine 112, which may also utilize machine learning techniques and one or more trained neural networks to identify an interference mitigation strategy to restore performance of communication system(s) in which WADER architecture 100 is utilized.

Deep Learning based on which DCNN used by classification component 206 operates is one where the learning happens in successive layers with each layer of the neural network adding to the knowledge of the previous layer without human intervention. Various known or to be developed deep learning techniques may be utilized to train classification component 206 for classifying interference signals.

The performance of a learned model can be measured by simple prediction accuracy or by the business metric the learned model is designed to support. Performance depends on the degree to which the training data matches the real world, the choice of algorithm, the algorithm's parameters, and the quantity of data. Unsupervised machine learning is another variation of machine learning where algorithms detect and discern attributes and features without the benefit of labeled training data. Some algorithms cluster data into meaningful groups by finding centers of data density. Other unsupervised algorithms use dimensionality reduction techniques (such as Singular-Value Decomposition—SVD) to uncover the essential attributes of the data without requiring a human to define those attributes in advance. This is particularly useful for “unstructured” data, such as images or text, where an underlying structure can be automatically inferred, enabling other algorithms to leverage the data. One advantageous aspect of deep learning is lack of manual intervention, which improves the accuracy of results. Trained neural networks utilized in the concepts described herein can be based on unsupervised, supervised, and/or reinforcement deep learning techniques.

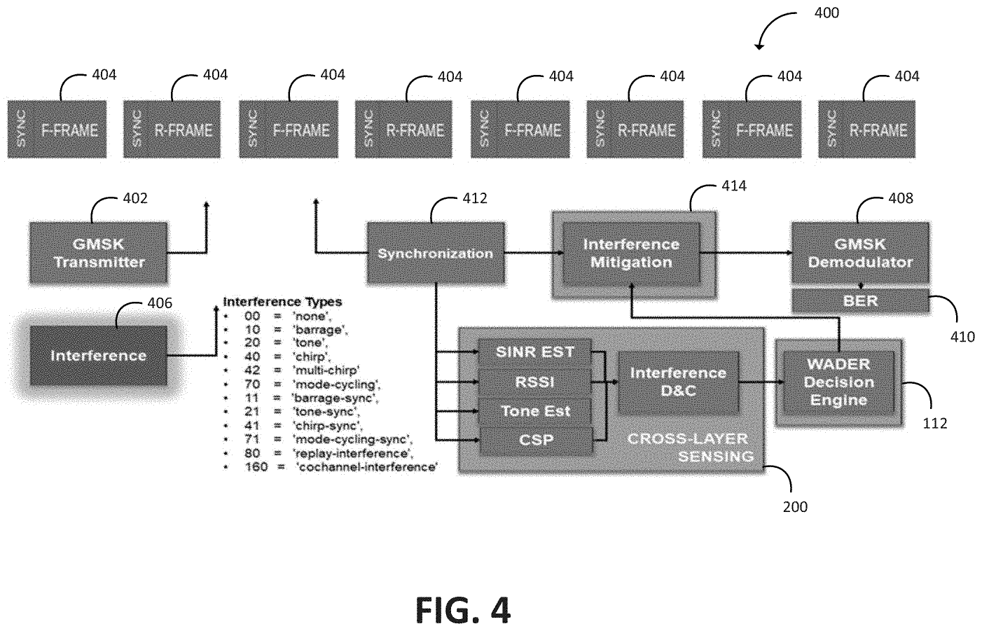

FIG. 4 illustrates an example radio system in which WADER architecture of FIGS. 1 and 2 can be utilized according to some aspects of the present disclosure.

Radio 400 of FIG. 4 can be a radio with GMSK based PHY layer. Transmitter 402 of radio 400 may transmit (and/or receive if also functioning as a receiver) signals via frames 404. Interference signal 406 may be present, which can be any of the interference types enumerated and defined as shown in FIG. 4 (e.g., 00, 10, 20, etc.).

Radio 400 may further include a GMSK modulator 408 that is configured to perform signal modulation and can provide information on BER 410. Synchronization component 412 may operate to implement interference mitigation strategies determined by, for example, WALDEN engine 112.

Embedded in radio 400 can be CLS engine 200 configured to perform functions described above including RF sensing and interference detection and classification (interference D&C) as described above with reference to FIG. 2. Output of CLS engine 104 can then be fed into WALDEN engine 112 to determine an interference mitigation scheme, which can then be implemented by interference mitigation component 414.

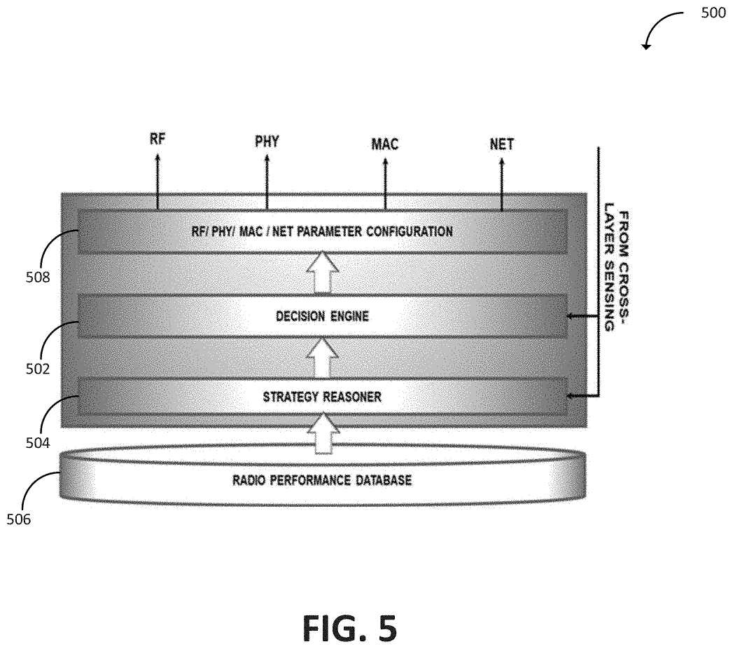

FIG. 5 illustrates an example architecture of WALDEN engine of FIG. 1 according to some aspects of the present disclosure.

Example architecture 500 of a WALDEN engine can include a decision engine 502, a strategy reasoner 504 (may also be referred to as a strategy engine 504), a radio performance database 506, which can be the same as database 114 of FIG. 1.

As can be seen from FIG. 5, output from CLS engine 200 may be fed into decision engine 502 and strategy reasoner 504. Using the output of CLS engine 200 and information from radio performance database 114, decision engine 502 can determine an interference mitigation scheme for restoring the underlying radio and nullifying (canceling) the interference effect. Such scheme can include information of changes to RF, and PHY, MAC, and NET layer configurations 508.

In one example, decision engine 502 is configured to determine an interference mitigation technique to use given that interference of type X this detected and classified by CLS engine 200.

In another example. decision engine 502 can utilize one or more trained neural networks to determine a proper interference mitigation scheme to use. The utilized model can be the same as that used for pattern classification and EW characterization/classification in CLS 200 with the difference being that while the DCNN framework can be used to characterize the EW technique based on multi-layer features, the DCNN for the FDE is used to make a decision on which mitigation technique to use based on the training data against various adversaries. That is, if a WADER node (e.g., an equipment with a receiver and/or WADER architecture of FIG. 1) encounters a two-tone interference, it may use Notch Filtering (NF) or Adaptive Interference Cancellation (AIC).

In another example, when a barrage interference is encountered, it is best to move away to a different frequency band. So, the interference mitigation strategy could be to use Dynamic Spectrum Access (DSA).

As mentioned above, trained neural networks and ML techniques can be used for both detection and classification of interference signals as well as determining an interference mitigation scheme inside CLS engine 200 and WALDEN engine 500, respectively.

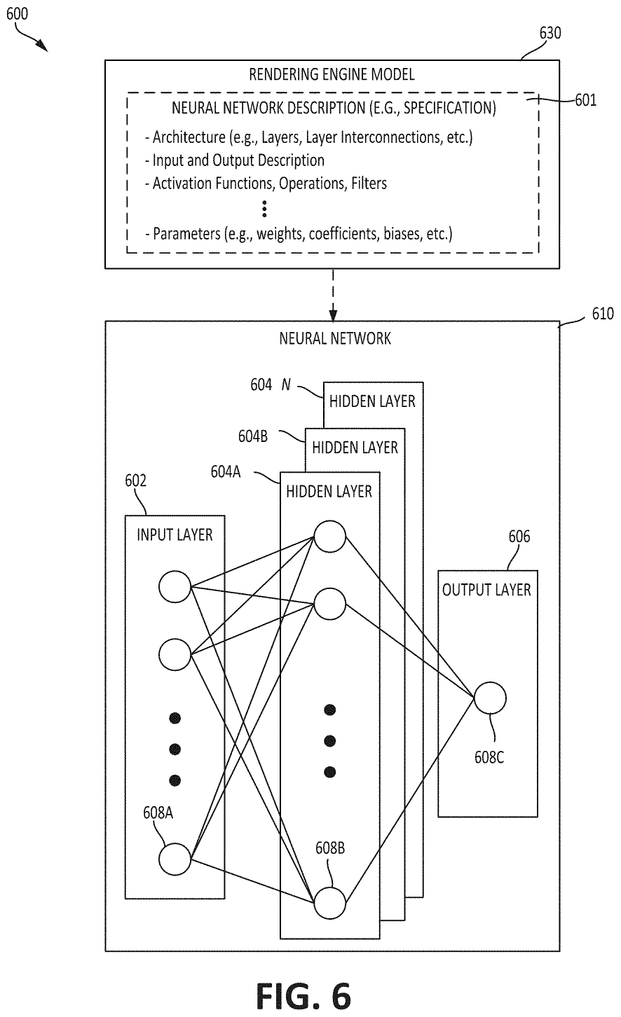

FIG. 6 illustrates an example neural network that can be trained to perform interference signal detection and classification, and/or interference mitigation scheme according to some aspects of the present disclosure.

Architecture 600 includes a neural network 610 defined by an example neural network description 601 in rendering engine model (neural controller) 630. Neural network description 601 can include a full specification of neural network 610. For example, neural network description 601 can include a description or specification of the architecture of neural network 610 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

In this example, neural network 610 includes an input layer 602, which can receive input data including, but not limited to, information on RF sensing, radio characteristics on PHY, MAC, NET layers, radio performance measurements, etc., in the example of using network 610 for interference detection and classification.

In the example of using network 610 for interference mitigation, input layer can receive information related to classification of detected interference(s).

Neural network 610 includes hidden layers 604A through 604N (collectively “604” hereinafter). Hidden layers 604 can include n number of hidden layers, where n is an integer greater than or equal to one. The number of hidden layers can include as many layers as needed for a desired processing outcome and/or rendering intent. Neural network 610 further includes an output layer 606 that provides as output, predicted classification of interference(s) received when network 610 is utilized for interference detection and classification. When using network 610 for determining an interference mitigation scheme, output layer 606 can output an interference mitigation scheme.

Neural network 610 in this example is a multi-layer neural network of interconnected nodes. Each node can represent a piece of information. Information associated with the nodes is shared among the different layers and each layer retains information as information is processed. In some cases, neural network 610 can include a feed-forward neural network, in which case there are no feedback connections where outputs of the neural network are fed back into itself. In other cases, neural network 610 can include a recurrent neural network, which can have loops that allow information to be carried across nodes while reading in input.

Information can be exchanged between nodes through node-to-node interconnections between the various layers. Nodes of input layer 602 can activate a set of nodes in first hidden layer 604A. For example, as shown, each of the input nodes of input layer 602 is connected to each of the nodes of first hidden layer 604A. The nodes of hidden layer 604A can transform the information of each input node by applying activation functions to the information. The information derived from the transformation can then be passed to and can activate the nodes of the next hidden layer (e.g., 604B), which can perform their own designated functions. Example functions include convolutional, up-sampling, data transformation, pooling, and/or any other suitable functions. The output of the hidden layer (e.g., 604B) can then activate nodes of the next hidden layer (e.g., 604N), and so on. The output of the last hidden layer can activate one or more nodes of output layer 606, at which point an output is provided. In some cases, while nodes (e.g., nodes 608A, 608B, 608C) in neural network 610 are shown as having multiple output lines, a node has a single output and all lines shown as being output from a node represent the same output value.

In some cases, each node or interconnection between nodes can have a weight that is a set of parameters derived from training neural network 610. For example, an interconnection between nodes can represent a piece of information learned about the interconnected nodes. The interconnection can have a numeric weight that can be tuned (e.g., based on a training dataset), allowing neural network 610 to be adaptive to inputs and able to learn as more data is processed.

Neural network 610 can be pre-trained to process the features from the data in the input layer 602 using the different hidden layers 604 in order to provide the output through output layer 606. In an example in which neural network 610 is used to predict usage of the shared band, neural network 610 can be trained using training data that includes past transmissions and operation in the shared band by the same UEs or UEs of similar systems (e.g., Radar systems, RAN systems, etc.). For instance, past transmission information can be input into neural network 610, which can be processed by neural network 610 to generate outputs which can be used to tune one or more aspects of neural network 610, such as weights, biases, etc.

In some cases, neural network 610 can adjust weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for neural network 610, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, neural network 610 is unable to determine low level features and thus cannot make an accurate determination of what the classification of the object might be. A loss function can be used to analyze errors in the output. Any suitable loss function definition can be used.

The loss (or error) can be high for the first training dataset (e.g., images) since the actual values will be different than the predicted output. The goal of training is to minimize the amount of loss so that the predicted output comports with a target or ideal output. Neural network 610 can perform a backward pass by determining which inputs (weights) most contributed to the loss of neural network 610, and can adjust the weights so that the loss decreases and is eventually minimized.

A derivative of the loss with respect to the weights can be computed to determine the weights that contributed most to the loss of neural network 610. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

Neural network 610 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, neural network 610 can represent any other neural or deep learning network, such as an autoencoder, a deep belief nets (DBNs), a recurrent neural networks (RNNs), etc.

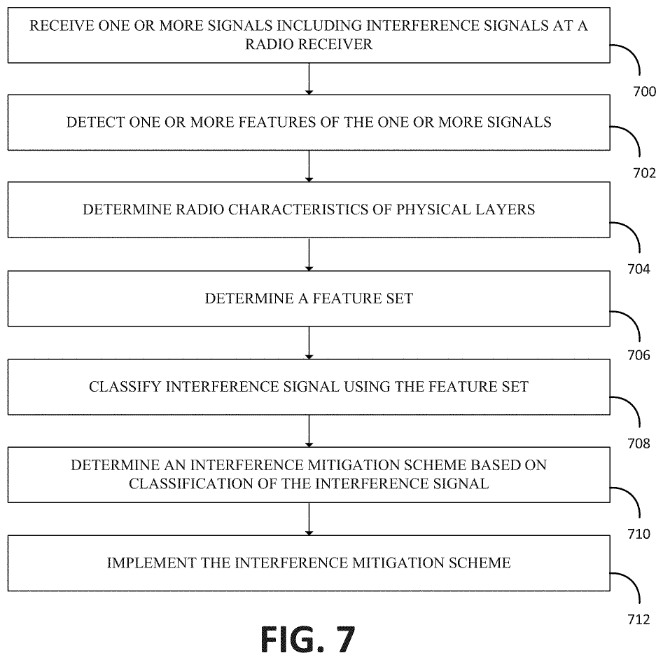

FIG. 7 illustrates an example process of classifying and mitigating an interference signal according to some aspects of the present disclosure. Steps of FIG. 7 may be performed by CLS engine 200 and/or WALDEN engine 112/500, both of which may be referred to as a controller inside a radio equipment.

At step 700, the method includes receiving one or more signals at a receiver (transceiver) of a radio. As noted above, the radio can be any radio or device capable of receiving RF signals over one or more frequency bands. The one or more signals may include signals containing data intended to be received by the radio and one or more interference signals.

At step 702, the method includes detecting (determining) one or more features in the one or more signals. In one example, the one or more features may be detected based on RF sensing as performed by CLS engine 200.

At step 704, the method includes determining one or more radio characteristics (inter-layer characteristics or simply layer characteristics) of one or more network layers (e.g., PHY, MAC, and NET), as described above with reference to FIG. 1 and FIG. 2.

At step 706, the method includes creating (determining) a feature set using the one or more features detected at step 702 along with one or more radio characteristics determined at step 704. In one example, this process may be performed by CLS engine 200 of FIG. 2 as described above.

At step 708, the method includes classifying an interference signal using the feature set. As described above, CLS engine 200 may utilize deep learning and one or more trained neural networks to classify the interference signal.

At step 710, the method includes determining an interference mitigation scheme for combating the interference signal and restoring the performance of the radio. In one example, the interference mitigation scheme maybe determined by WALDEN engine 112/500 using the classified interference signal as input. As noted above, WALDEN engine 112/500 may utilize one or more trained neural networks to determine the interference mitigation scheme.

At step 712, the method includes implementing the interference mitigation scheme. As described above with reference to FIG. 5, a mitigation scheme may entail reconfiguration and/or otherwise modification of one or more parameters associated with either the RF signals transmitted by the radio and/or configurations of one or more network layers (e.g., PHY, MAC, and/or NET layers).

With example embodiments of WADER architecture and its functionalities described above, the disclosure next provides results of simulation tests performed using the disclosed WADER architecture.

### Simulation Results

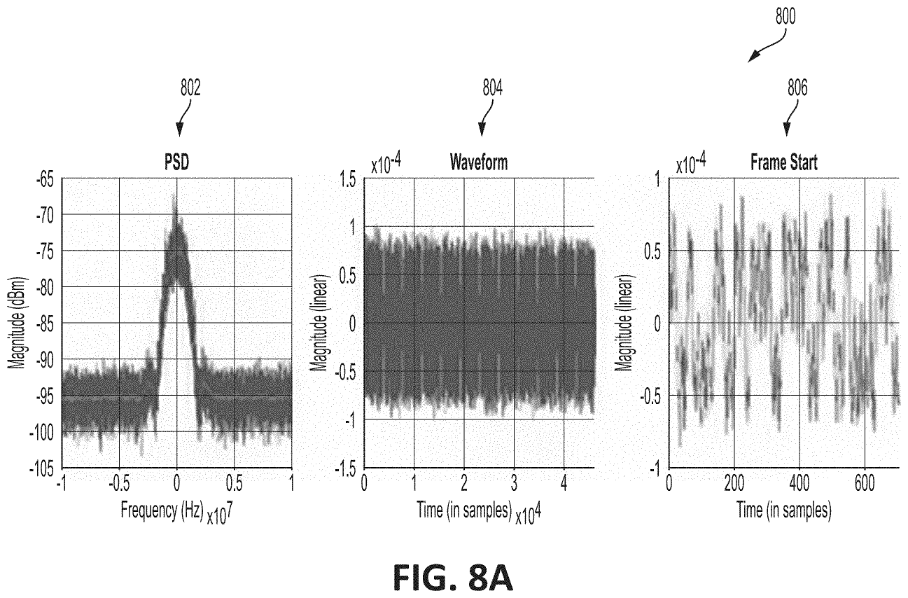

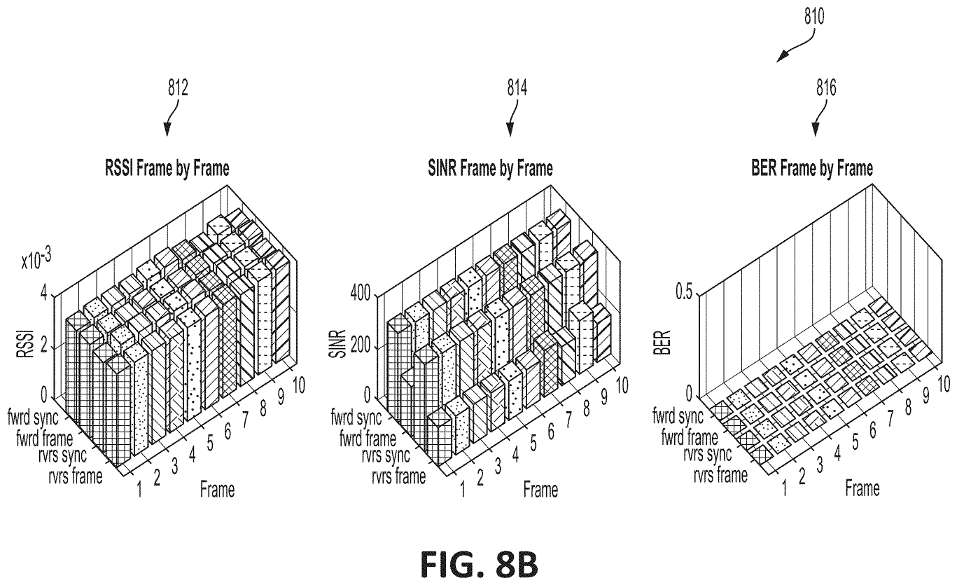

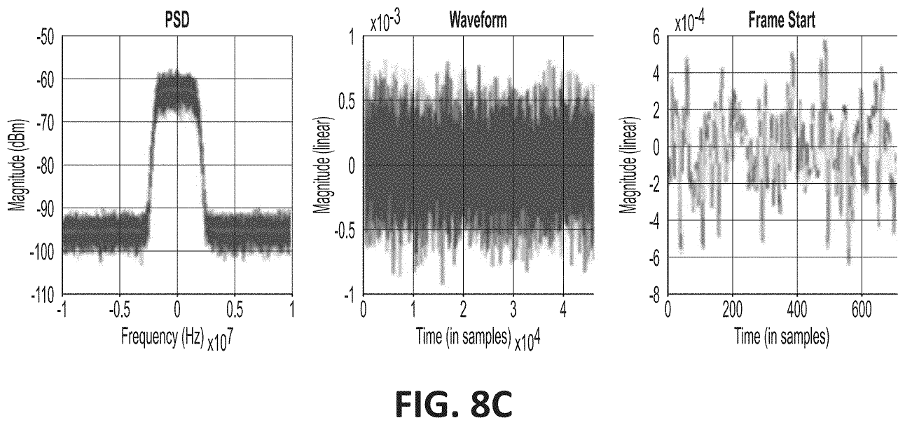

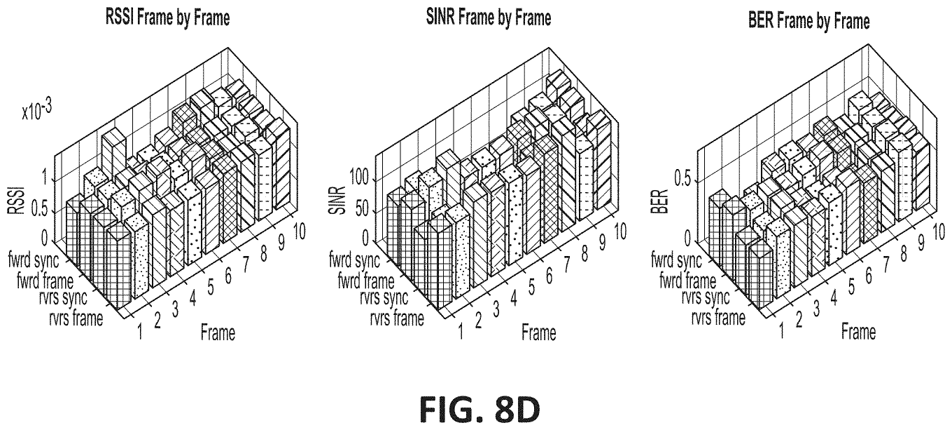

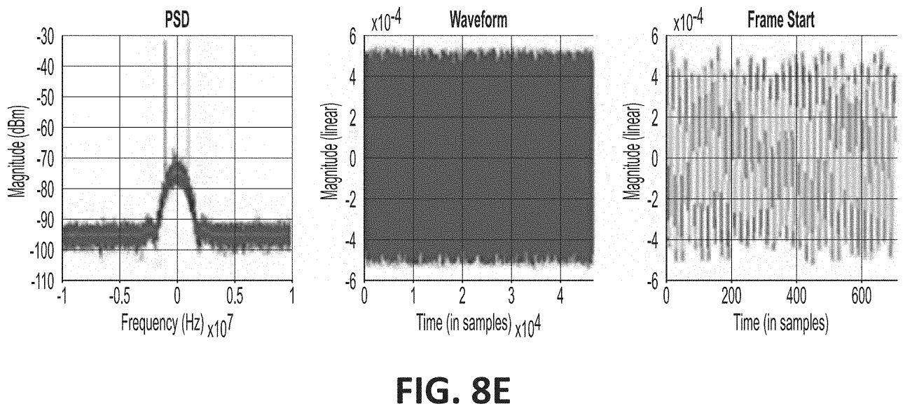

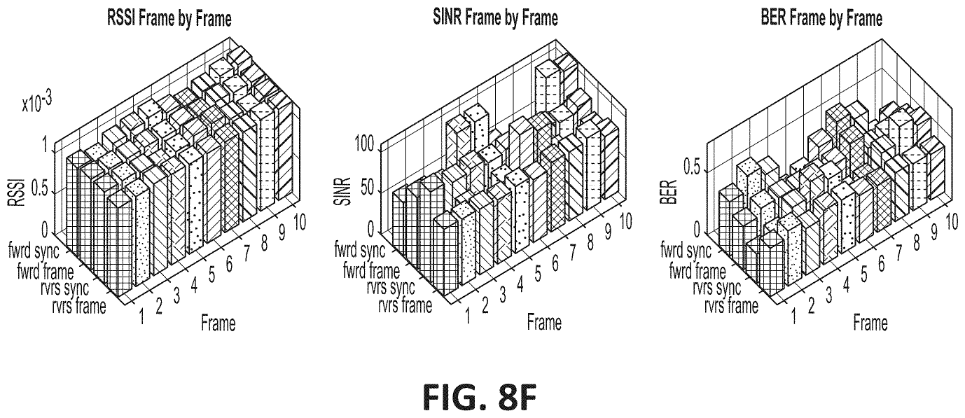

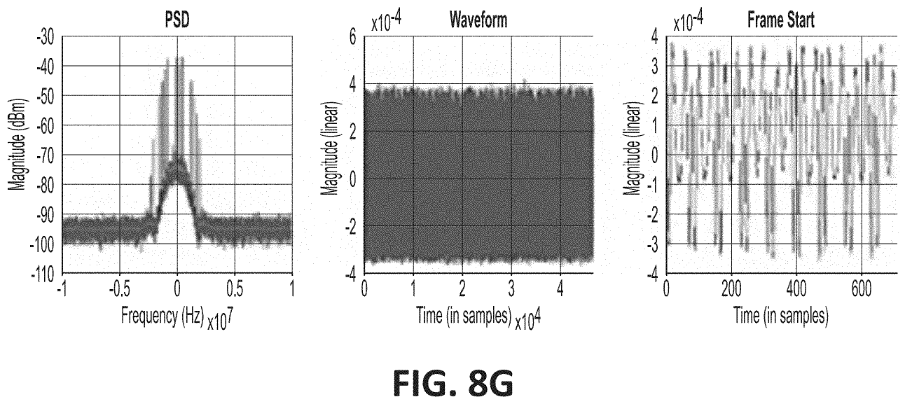

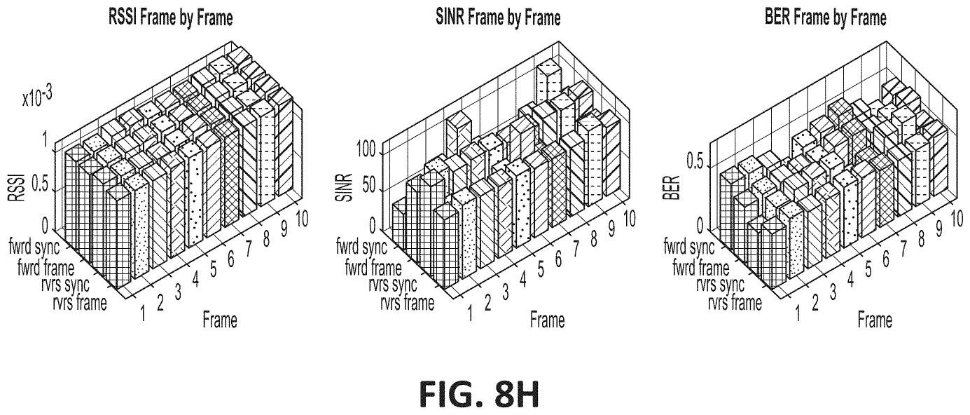

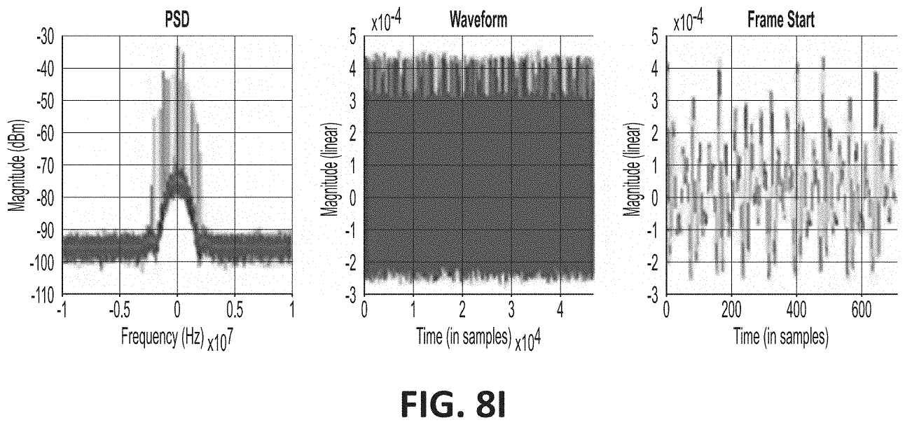

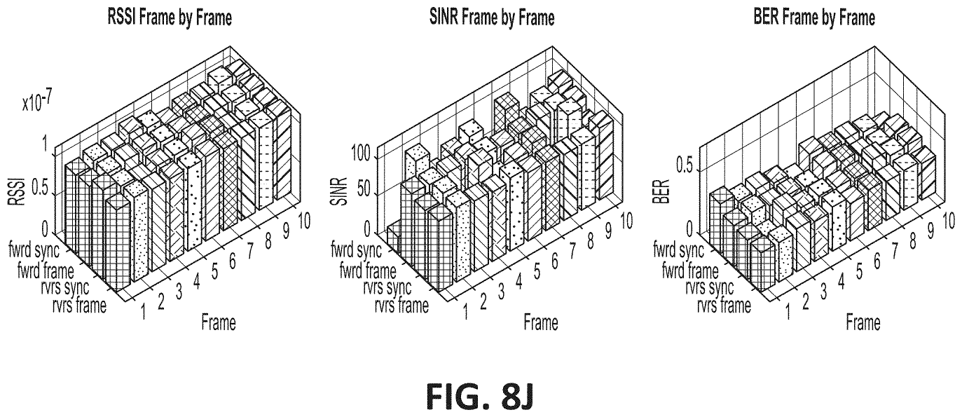

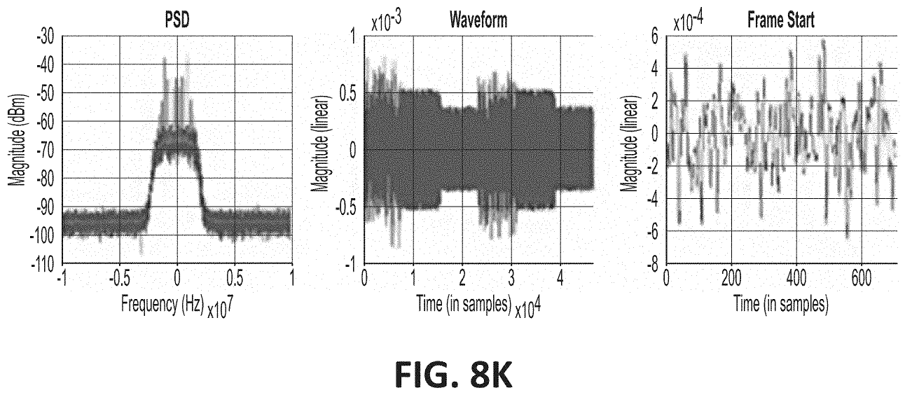

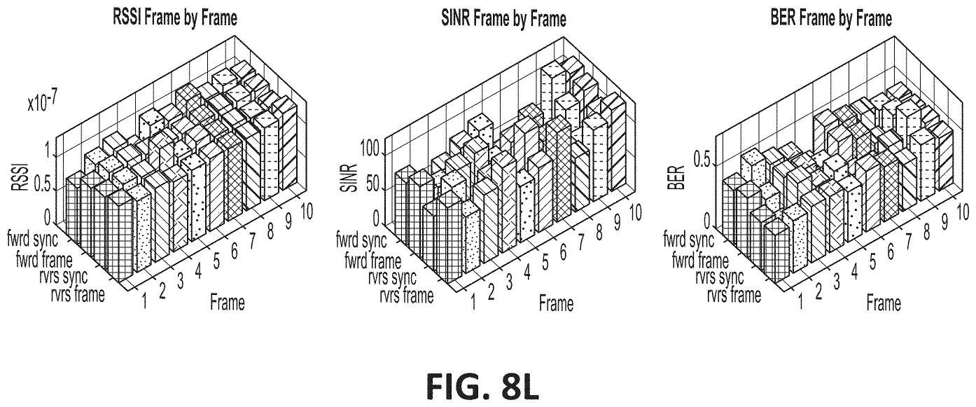

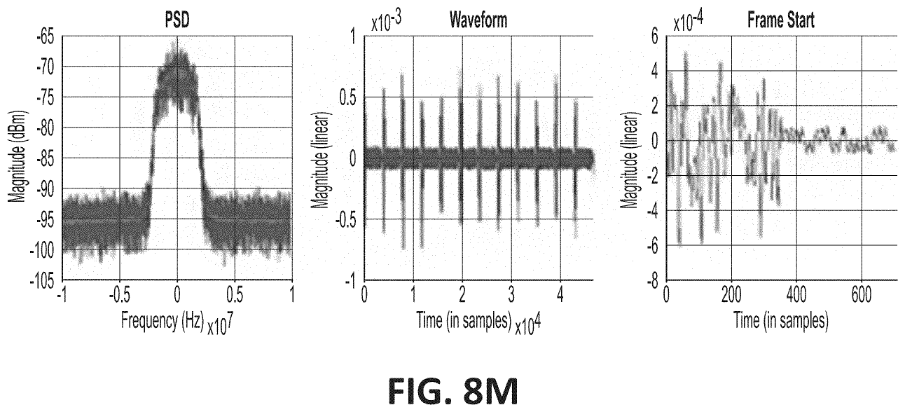

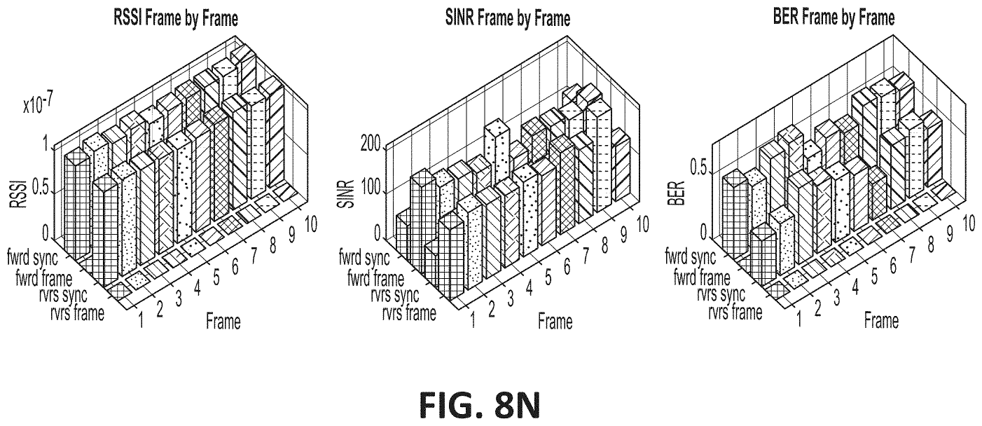

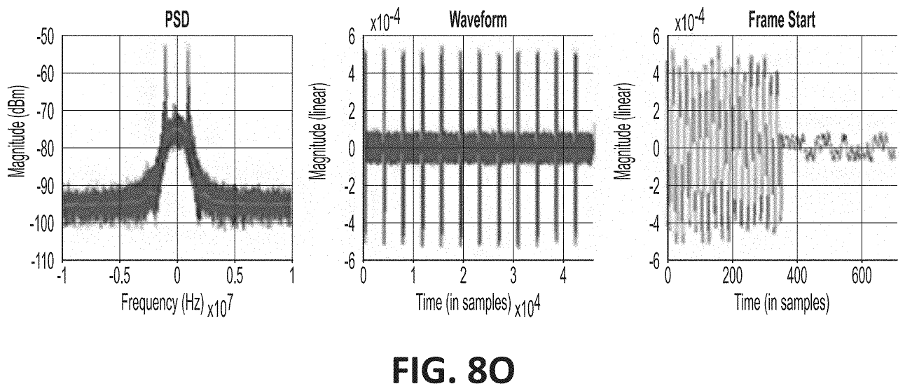

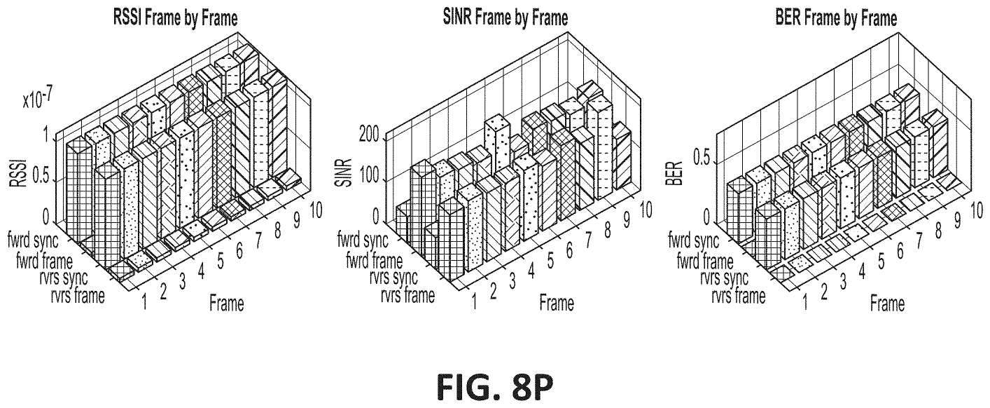

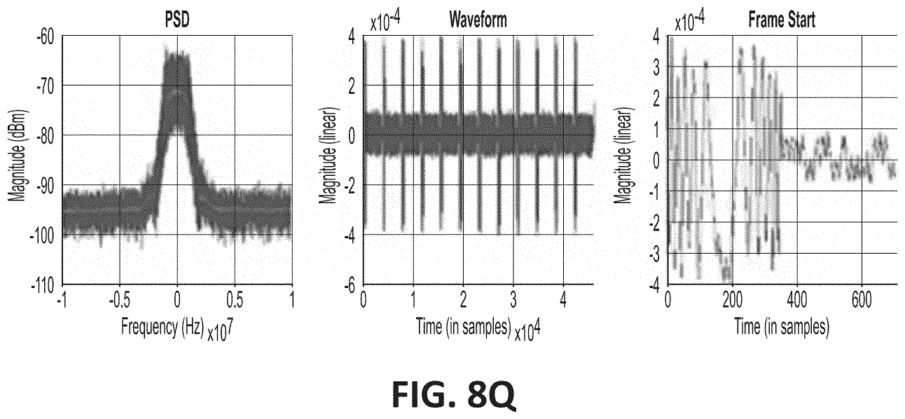

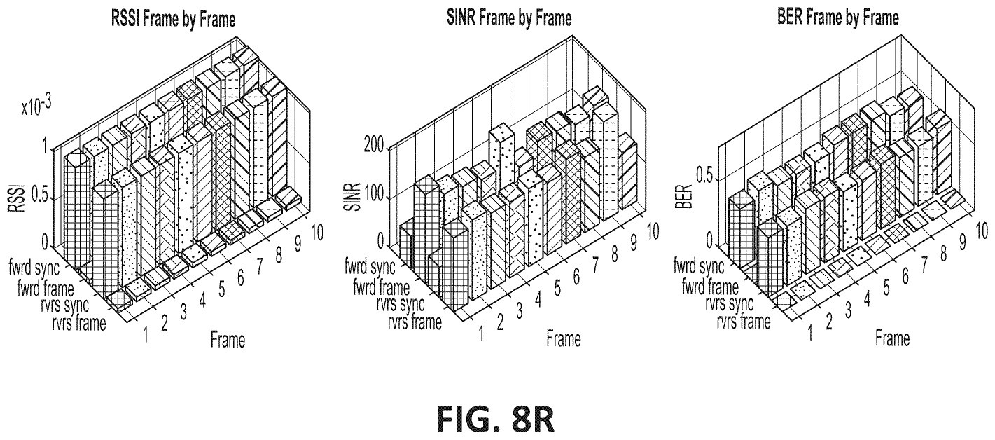

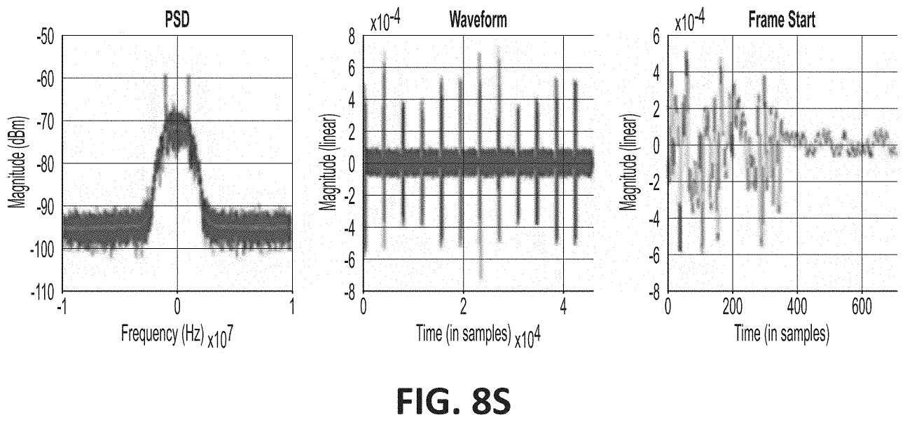

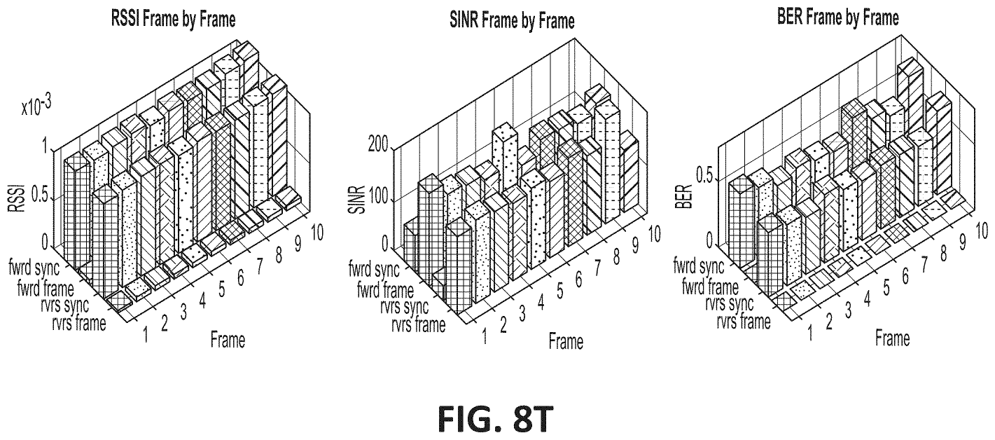

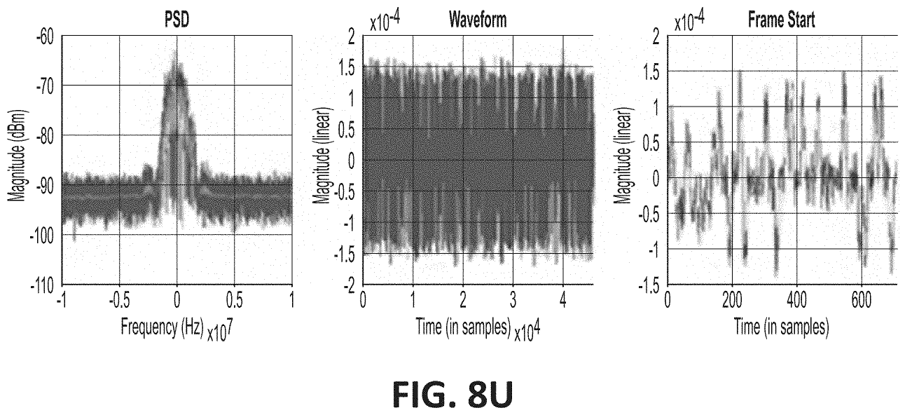

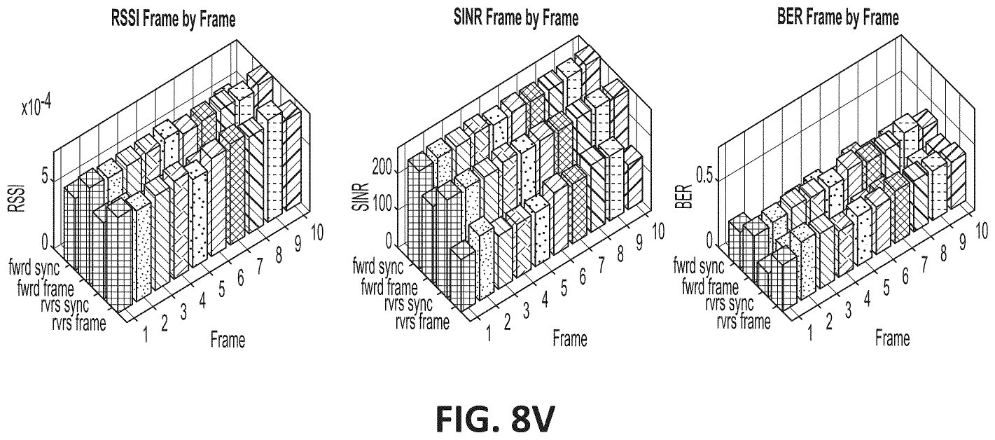

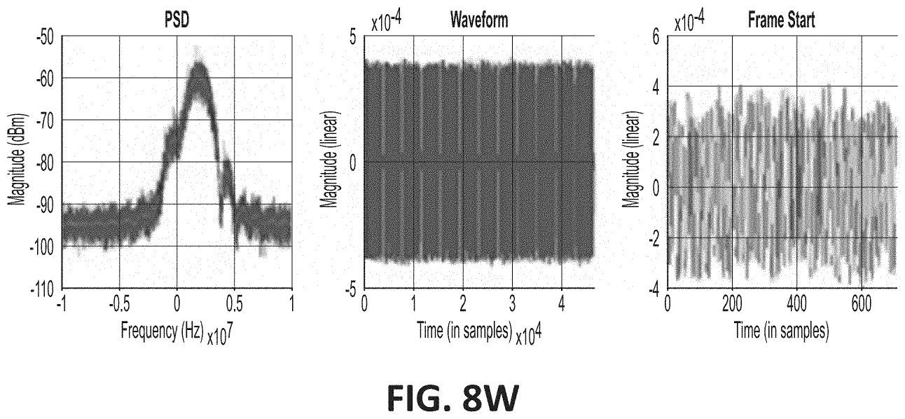

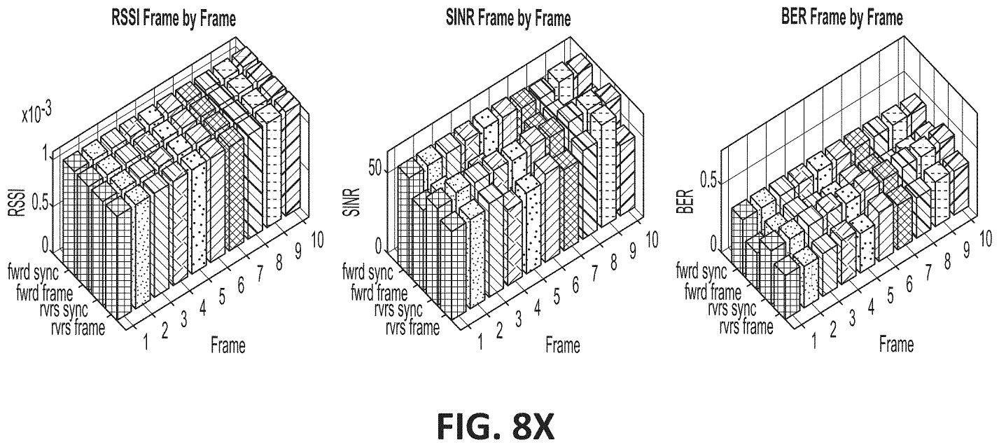

FIGS. 8A-X illustrates example outputs of simulation tests for interference detection, classification, and mitigation according to some aspects of the present disclosure. Results shown in FIGS. 8A-X are for simulations of a GMSK based radio as described with reference to FIG. 4. More specifically, a prototype simulation environment that generated 12 interference types along with a generic GMSK is conducted. A feature matrix was generated for this simulation and fed into a DCNN, which characterizes the type of interference as described above. The set of features were divided into CLS features (e.g., BER, RSSI, SINR values, CSP features, PSD, detected tones, and spectral correlation function, both conjugate and non-conjugate, and spectral coherence values, again both conjugate and non-conjugate). Finally, there was developed several interference mitigation techniques applied in a simulated event-driven scenario. GMSK data link using TDMA frame structure is created for simplicity, consisting of synchronization packets and sub-frames (per frames 404 of FIG. 4).

Output 800 of FIG. 8A shows the normal operations of the GMSK waveform without interference. Plot 802 is the PSD. Plot 804 shows the real portion waveform for multiple frames, and plot 806 shows a zoomed in plot of the real portion of waveform at the beginning of the first frame.

Output 810 of FIG. 8B shows example CLS features (e.g., RSSI, SINR, and BER) during normal operations. CLS features for each subframe portion can be determined across multiple frames. That is four numbers for each frame: the CLS features for the forward sync, forward payload, reverse sync, and reverse payload. This results in a 4×N matrix of values, where N is the number of frames observed. In the figure, plot 812 is the RSSI, plot 814 is the SINR, and plot 816 is the BER.

The remaining FIGS. 8C-8X show representative examples of 11 types of interference modeled in the same format as the above.

Both the signal and the interference were referenced with respect to the noise floor. That is, SNR and INR values were used, with a Noise Floor of about −95 dBm. In our simulations, the SNR remained fixed at 10 dB while the INR ranged from 15 dB to 30 dB.

FIGS. 8C and 8D show Barrage Interference, which is bandpass filtered AWGN noise. The noise is bandpass filtered because it is assumed the interferer is making efficient use of their power budget. In general, the Barrage Interference is controlled by two parameters: a center frequency and a bandwidth. In the figure, it can be seen that the bandlimited noise overpowers the GMSK signal and creates a plateau-like PSD.

FIGS. 8E and 8F show Tone and Multi-tone Interference. Inserting high power tone or multiple tones is an effective way to create harmonics and throw the receiver mixer off.

FIGS. 8G and 8H show Chirp interference while FIGS. 8I and 8J show multi-chirp interference. A single chirp is constructed as a tone with a linearly increasing frequency over some period of time. In the case of multi-chirp, this is a sum of some number of multiple phase-shifted chirps. The chirp is then repeated indefinitely. Due to the periodic form of this interference, it creates a “jailcell” of harmonics that appear in the PSD. The harmonics are symmetric in the case of a single chirp and asymmetric in the multi-chirp case. The parameters that control these types of interference can be the center frequency, bandwidth, chirp duration, and number of chirps.

FIGS. 8K and 8L show Mode-cycling interference, where the interference cycles over a period of time between different types. In addition to the choice of composite interference types and all their parameters, the length of time to use each type of interference must also be specified and its offset relative to the start of the GMSK signal. Mode cycling interference were modeled as first Barrage, then Tone, then (single) Chirp Interference and an offset of zero and duration equal to the length of the GMSK frame were chosen. The PSD appears as a composite of each of the individual types due to the averaging nature of the PSD statistic. Each of the above types of interference—Barrage, Tone, Chirp, and Mode Cycling—have a corresponding “Synchronization Sequence (SS) Interference” form of interference where the interference is targeted at the synchronization sequence. This is a smart way to incapacitate a radio with high power budget efficiency.

FIGS. 8M and 8N show Barrage Sync, FIGS. 80 and 8P show Tone Sync interference, FIGS. 8Q and 8R shown Chirp Sync, and FIGS. 8S and 8T show Mode Cycling Sync Interference types, respectively. Their PSDs look similar to their non-sync counterparts except their features are subdued because, while the instantaneous power when active is the same, the average power of the interference is lower. Visually, over multiple frames, we can see the targeted aspect of the interference when plotting the real portion of the received signal. In each of the Sync Interference types, the CLS features display a “Manhattan-like” pattern. Finally, there are two more types of interference modeled: Cochannel interference and Replay interference. Cochannel interference is interference resulting from an identical GMSK waveform but slightly offset in the frequency domain. It may also be offset in the time domain. Its representative PSD and CLS features can be seen in FIGS. 8U and 8V. Replay interference is interference created by capturing the GMSK signal and replaying it with significant power, resulting in a time delayed GMSK waveform. Because of this capture and replay aspect, additional noise is added onto to signal. We assumed that the SNR of the captured and replayed signal is similar to the SNR of the intended radio. Representative PSD and CLS features are shown in FIGS. 8W and 8X.

A DCNN on a set of 21×128 feature matrices such as feature matrix 300 of FIG. 3 was trained. The structure of the matrix 300, as shown in FIG. 3, is comprised of first 12 rows of CLS features across 128 frames: 4 rows for RSSI, 4 rows for SINR, and 4 rows for BER. Each CLS feature group has 4 rows because there are 4 sections of each GMSK frame. When Sync BERs exceeded a certain threshold, Packet BERs were assumed to be 0.5. The next row contains the PSD with computed with relative spectral resolution of 1/128. The next two rows contain a sorted list of present tones and their amplitudes, respectively. The last 6 rows contain CSP features. When the number of significant tones or Cycle Frequencies is less than 128, the extract space in the matrix was filled with zeros. The feature matrix was normalized in order to have feature rows with different magnitudes have equal effect in the training process. 100 signals of each of the 12 types for a total dataset size of 1200 were generated. The SNR remained fixed at 15 dB and the INRs ranged from 15 dB to 30 dB. The parameters that control each type of interference were varied across limited ranges. The architecture of the DCNN used had a small number of layers, separated into a feature discovery group of layers and a classification group of layers. For the feature discovery layers, after the initial normalization process, convolution layer was used, followed by a normalization layer, and then an ReLU layer. This was passed into the classification layers, which was comprised of a fully connected layer, a softmax layer, and then finally a classification layer, which returned the classification result. The data was split into 70% training, 15% validation, and 15% testing datasets.

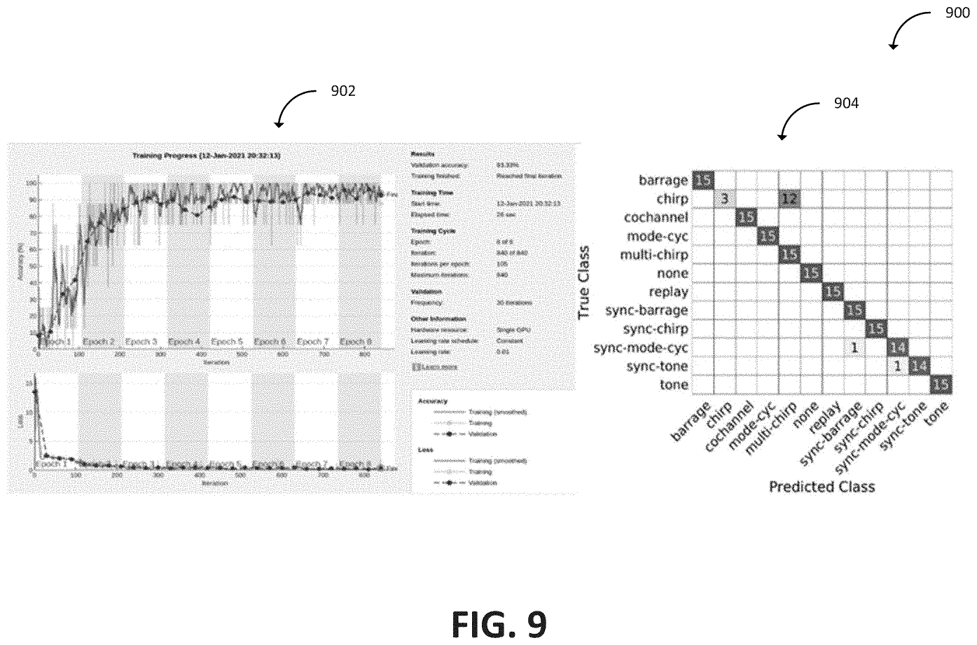

FIG. 9 illustrates an example of neural network training according to some aspects of the present disclosure. Schematic 900 includes an output 902 of a MATLAB DCNN training process and an output 904 showing a confusion matrix for the CNN applied to a test dataset. Time to train took around 30 seconds with training accuracy above 90%. Within the figure on the right is the confusion matrix generated by applying the trained Neural Network on the test dataset. Results are near-perfect. The only real flaw is the inability to discriminate between Chirp and Multi-Chirp Interference. However, both of these types are essentially the same kind of interference with similar mitigation strategies. The result here shows excellent potential to characterize and classify the type of interference.

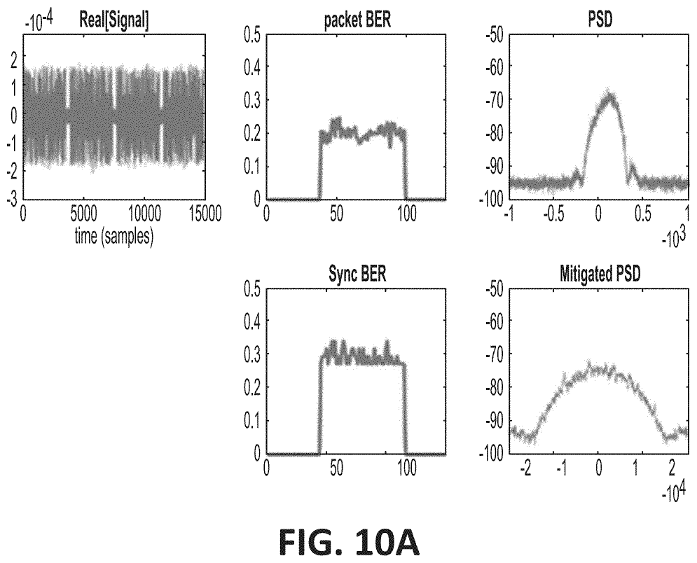

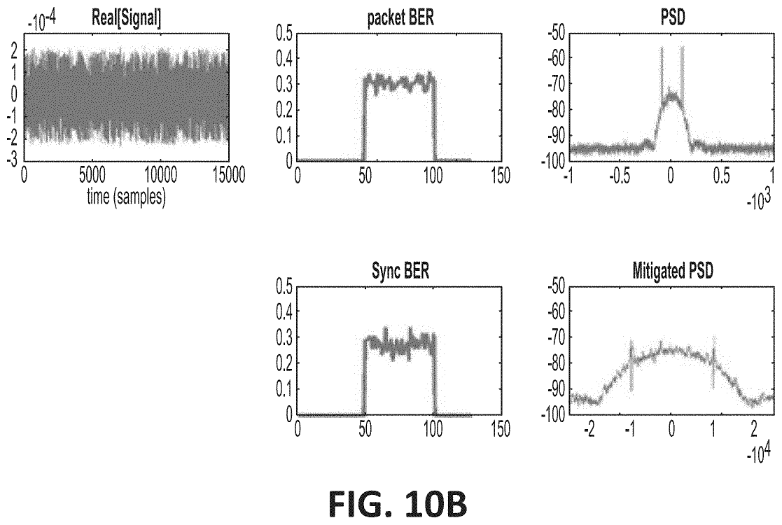

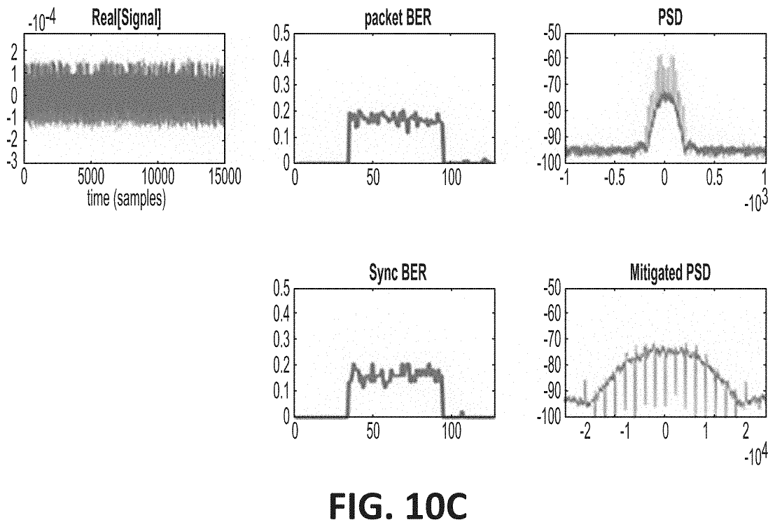

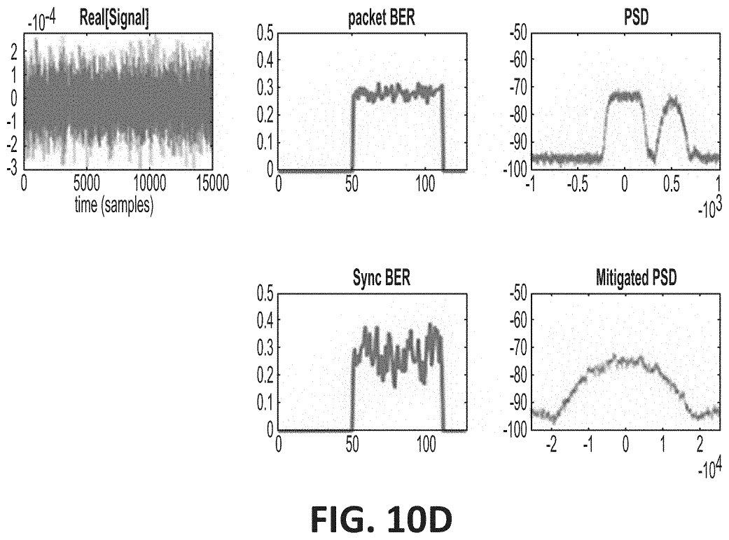

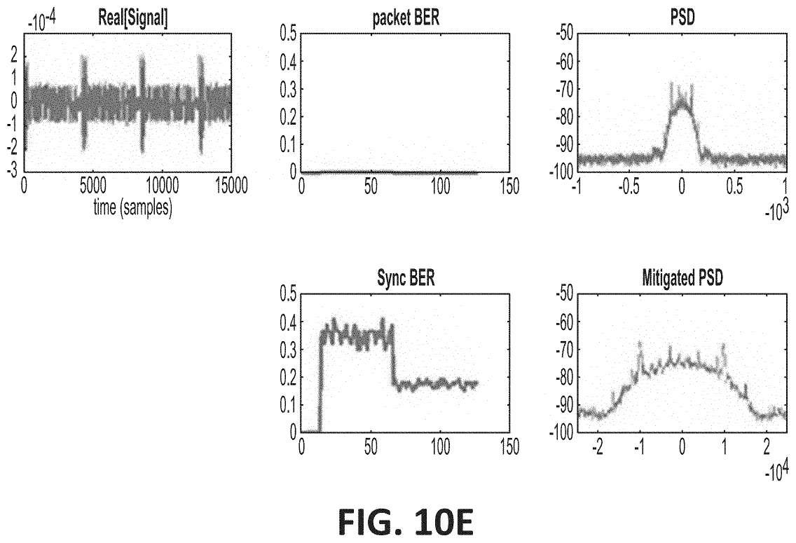

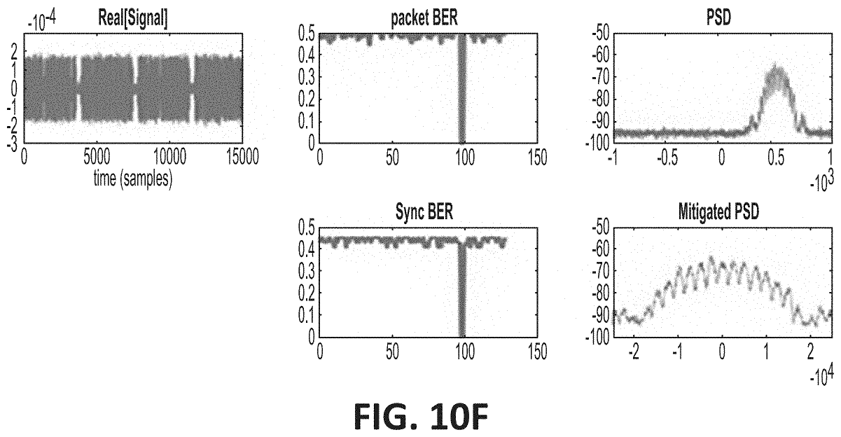

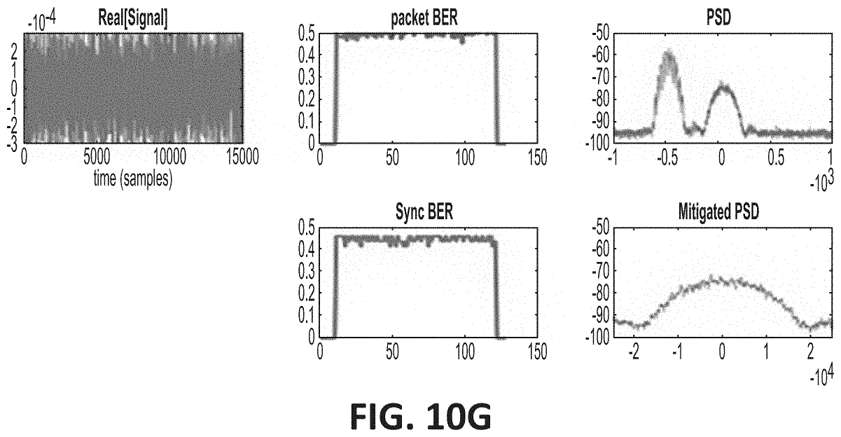

Interference Mitigation techniques include at least two types: processing of the received signal on the receiver's end and datalink parameter changes. FIGS. 10A-G illustrate examples of channel interference according to some aspects of the present disclosure. In FIG. 10A, we have cochannel interference. Once classified, the receiver demodulates the second GMSK signal, reconstructs this signal as transmitted, estimates the channel impulse response, followed by Interference Excision using Adaptive Filter techniques. The intended signal is then recovered with low error rates. No parameters are modified. Tone interference is managed by estimating the present tones and filtering them out with a notch filter. FIG. 10B shows an event-driven scenario over time where Notch Filtering is used to mitigate interference. First, there is no interference. Packet BERs and sync BERs are excellent. Then the onset of tone interference occurs, resulting in disruptive BERs. Finally, tone interference remains, yet the receiver has recognized the type, estimated the tones, and responded by using a notch filter to remove these tones. The zoomed in Mitigated PSD is shown in the lower right plot. In FIG. 10C, a similar story is shown, but with a different interference type. In this case, chirp interference occurs and disrupts the comms. Once detected and classified, it uses Adaptive Excision Techniques. This results in improved BERs. In FIG. 10D, Barrage Interference can be seen, which cannot be dealt with by applying filter. Instead, the receiver implements a Dynamic Spectrum Access parameter modification strategy and moves the signal to a different channel. At the new channel center frequency, the zoomed into PSD of the GMSK waveform looks perfectly fine. When Sync Interference occurs, SYNC Sequence Extension or Mechanism Hopping is used. SYNC Sequence extension extends the Synchronization Sequence. Mechanism Hopping would adaptively move the position of the Synchronization Sequence. This was not implemented during Phase I. FIG. 10E shows this scenario. The theoretical packet BER remains good during the interference yet the sync BER is maximally disrupted. When the receiver recognizes the interference type, it signals to extend the synchronization sequence thereby increasing the gain. This is reflected by the sync BER decreasing by half, assuring that the receiver can correctly identify at least the latter portion of the sequence. The last mitigation strategy shown in FIGS. 10F and 10G highlights the possible cat-and-mouse aspect of interference mitigation as it assumes a model of the interferer's actions. Replay interference is not mitigated by DSA as the interferer is assumed to search in-band for the location of the largest present signal, filter out everything but that signal, and replay the result. If we move our signal the interferer will find it again. Instead, we use a dummy signal or Spectral Honeypot signal that is much larger than the intended comms signal which the interferer will instead latch on to.

With example embodiments for interference detection, classification, and/or mitigation described above, one or more exemplary enhancements to the underlying processes will be described next.

Described below is example processes for adopting physical unclonable functions (PUF) derived from IoT devices in communication, and how to encode these PUFs into credentials to irrevocably link device identifiers to devices. The IoT sensor devices today use various traditional techniques for network and link level security. These include: 1) Network key security, 2) Link-key security, 3) Certificate based key establishment. These traditional techniques may be broken easily with the advent of quantum computing especially since they rely on a pseudo-random number generator which is used for key generation that may be implemented in hardware using simple shift registers. Secondly, these protocols do not periodically generate new keys. Ideally, every device and every session need to be protected. When such keys constantly change, things become harder for the adversary to break the security.

Given that the IoT architectures are not amenable to traditional methods of secure communication such as data encryption, there has been an increase in interest in the potential of the physical properties of the radio channel itself to provide communications security. Physical layer security has the potential to address these concerns by taking advantage of the fundamental ability of the physics of radio propagation to provide certain types of security. Use of multiple input multiple output (MIMO) techniques where multiple transmit and receive antennas are used to boost capacity can be further exploited to boost the security in wireless channels. This is because a MIMO channel is that much harder to be exploited by an eaves-dropper (Eve).

There has also been interest in the use of AI and machine learning techniques in communications. Use of AI enhanced techniques combined with physical properties of the radio channel is something very new that we propose to research and develop on this project for making the edge IoT devices quantum safe. This can be termed Ai-CS. While the IoT devices themselves may not have computing and memory resources, all of them do have at least one wireless modulator and demodulator (MODEM) which performs communications procedures such as synchronization, channel estimation. It has been shown that the two principal properties of radio transmission—namely, diffusion and superposition—can be exploited to provide data confidentiality through several mechanisms that degrade the ability of potential eavesdroppers to gain information about confidential messages. These mechanisms include the exploitation of fading, interference, and path diversity (through the use of multiple antennas), all of which lead to techniques for implementation in low-cost wireless devices.

The essential concept revolves around the creation of a shared secret between the IoT devices and to the 5G network by exploiting the correlation experienced by Alice (A) and Bob (B) between their channels. All communications systems use training signals during synchronization process for channel estimation and time and frequency synchronization. Assuming that Alice and Bob send training signals that allow them to estimate their channels. This results in creation of a shared secret. The secret key of rate Rₖ is given by the following expression:

$${R}_{K} = \frac{1}{T} I ( {\tilde{h}}_{AB} ; {\tilde{h}}_{BA} ) = \frac{1}{2 T} log ( 1 + \frac{{σ}_{1}^{1} {P}^{2} {T}^{2}}{4 ( {σ}^{1} + {σ}^{2} {σ}_{1}^{2} P T )} )$$

where, h_{AB} and h_{BA} are the channels from Alice to Bob and Bob to Alice, T is the coherence time of the channel denoting how fast the channel changes and P is the transmit power. As the channel coherence time T increases, the key rate diminishes. Hence, a faster varying channel is beneficial. In one example, one can use properties of the signals (e.g., features extracted and/or layer characteristics determined by CLS 200) and combine them with the channel to then enable secure communications. This further enhances security in the distributed IoT setting.

WADER architecture and various aspects thereof can be used in a variety of applications across different industries.

For instance, there can be military applications for WADER. Protected satellite communications are crucial for success of military missions. Information sent around the world may be intercepted by adversaries and thus should be kept safe, secure and protected. On the ground, the satellite dishes and terminal systems combine to form a communications network that dramatically reduces the chances for interference or interception.

Another application for WADER would be commercial and federal transition. As commercial airwaves become more and more congested and contested due to the advent of Massive Machine to Machine (M2M) Communications, the WADER machine learning enabled intelligent decision engine can help the radios to strategically and tactically choose the best configuration to minimize and mitigate the interference. This technology not only applies to the licensed spectrum where 5G and 6G systems are likely to be deployed, but also license-exempt users such as next generation Wi-Fi (e. g. Wi-Fi 6, IEEE 802.11ac, ax and other standards). Any and every spectrum band, where spectrum is re-farmed, and where new cognitive radio technologies are required to share the spectrum with the primary users, WADER can provide this cognitive piece to optimize the resources across the spectrum and the network. Note that, every year telecom operators spend upwards of $600 M in the United States alone to identify the sources of interference and potentially mitigate them.

We WADER will allow the radios to make a better decision on the mitigating techniques and strategies while keeping the architecture be waveform agnostic. Commercial applications of WADER include robust resilient communications for private security industry, air traffic control, first responders counter terrorism, utility industry which is subjected to nation-state attacks and bands that require spectrum sharing (e. g. CBRS, 1.7 GHz and others) where intelligent decision making is desired. EA against private sector targets may also likely counter non-malevolent interference events in congested RF environments. Other applications include space missions and communications, private 5G networks, smart cities, etc.

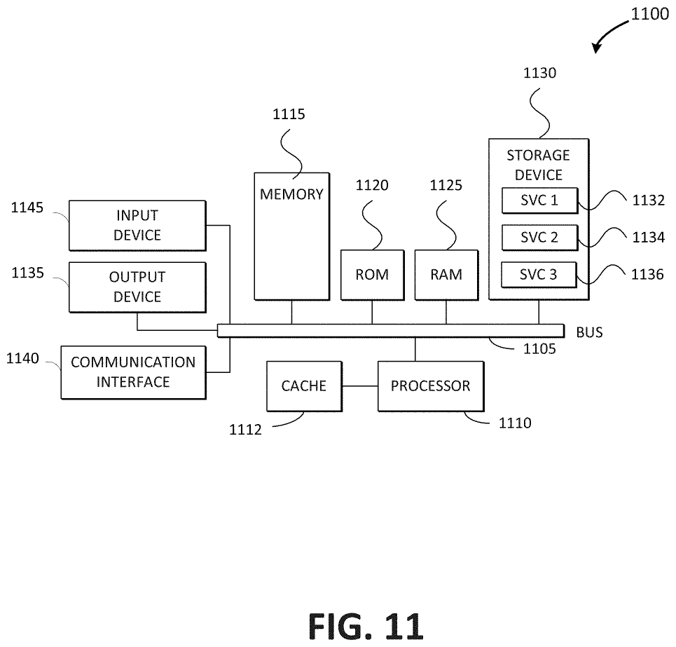

FIG. 11 illustrates an example network device according to some aspects of the present disclosure. Example of computing system 1100 of FIG. 11 can be used to implement one or more component of the example systems and architectures described above with reference to FIGS. 1-10 including, but not limited to, any component of WADER architecture 100 of FIG. 1. Connection 1105 can be connection connecting various components of the computing system 1100. For example, connection 1105 can a physical connection via a bus, or a direct connection into processor 1110, such as in a chipset architecture. Connection 1105 can also be a virtual connection, networked connection, or logical connection.

In some embodiments computing system 1100 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 1100 includes at least one processing unit (CPU or processor) 1110 and connection 1105 that couples various system components including system memory 1115, such as read only memory (ROM) 1120 and random access memory (RAM) 1125 to processor 1110. Computing system 1100 can include a cache of high-speed memory 1112 connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 can essentially be a completely self-contained computing system, containing multiple cores or processors, a bus, memory controller, cache, etc. A multi-core processor can be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms known to those of skill in the art. In some instances, multimodal systems can enable a user to provide multiple types of input/output to communicate with computing system 1100. Computing system 1100 can include communications interface 1140, which can generally govern and manage the user input and system output. There is no restriction on operating on any particular hardware arrangement and therefore the basic features here can easily be substituted for improved hardware or firmware arrangements as they are developed.

Storage device 1130 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 1130 can include software services, servers, services, etc., that when the code that defines such software is executed by the processor 1110, it causes the system to perform a function. In some embodiments, a hardware service that performs a particular function can include the software component stored in a computer-readable medium in connection with the necessary hardware components, such as processor 1110, connection 1105, output device 1135, etc., to carry out the function.

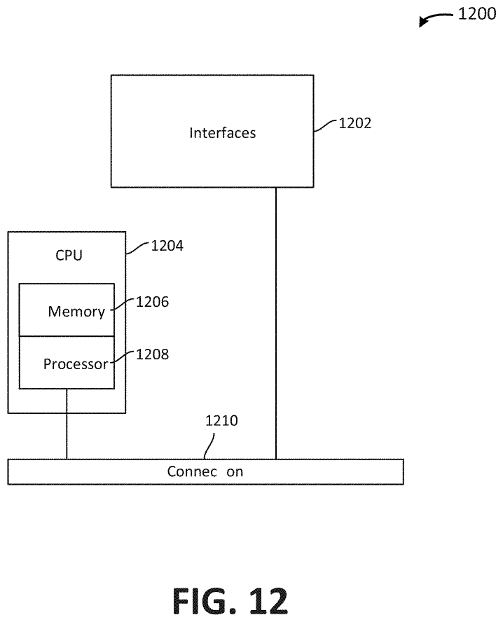

FIG. 12 illustrates an example network device 1200 suitable for performing switching, routing, load balancing, and other networking operations. The example network device 1200 can be implemented as switches, routers, nodes, metadata servers, load balancers, client devices, and so forth.

Network device 1200 includes a central processing unit (CPU) 1204, interfaces 1202, and a bus 1210 (e.g., a PCI bus). When acting under the control of appropriate software or firmware, the CPU 1204 is responsible for executing packet management, error detection, and/or routing functions. The CPU 1204 preferably accomplishes all these functions under the control of software including an operating system and any appropriate applications software. CPU 1204 can include one or more processors 1208, such as a processor from the INTEL X86 family of microprocessors. In some cases, processor 1208 can be specially designed hardware for controlling the operations of network device 1200. In some cases, a memory 1206 (e.g., non-volatile RAM, ROM, etc.) also forms part of CPU 1204. However, there are many different ways in which memory could be coupled to the system.

The interfaces 1202 are typically provided as modular interface cards (sometimes referred to as “line cards”). Generally, they control the sending and receiving of data packets over the network and sometimes support other peripherals used with the network device 1200. Among the interfaces that can be provided are Ethernet interfaces, frame relay interfaces, cable interfaces, DSL interfaces, token ring interfaces, and the like. In addition, various very high-speed interfaces can be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces can include ports appropriate for communication with the appropriate media. In some cases, they can also include an independent processor and, in some instances, volatile RAM. The independent processors can control such communications intensive tasks as packet switching, media control, signal processing, crypto processing, and management. By providing separate processors for the communication intensive tasks, these interfaces allow the master CPU (e.g., 1204) to efficiently perform routing computations, network diagnostics, security functions, etc.

Although the system shown in FIG. 12 is one specific network device of the present disclosure, it is by no means the only network device architecture on which the present disclosure can be implemented. For example, an architecture having a single processor that handles communications as well as routing computations, etc., is often used. Further, other types of interfaces and media could also be used with the network device 1200.

Regardless of the network device's configuration, it can employ one or more memories or memory modules (including memory 1206) configured to store program instructions for the general-purpose network operations and mechanisms for roaming, route optimization and routing functions described herein. The program instructions can control the operation of an operating system and/or one or more applications, for example. The memory or memories can also be configured to store tables such as mobility binding, registration, and association tables, etc. Memory 1206 could also hold various software containers and virtualized execution environments and data.

The network device 1200 can also include an application-specific integrated circuit (ASIC), which can be configured to perform routing and/or switching operations. The ASIC can communicate with other components in the network device 1200 via the bus 1210, to exchange data and signals and coordinate various types of operations by the network device 1200, such as routing, switching, and/or data storage operations, for example.

For clarity of explanation, in some instances the present technology can be presented as including individual functional blocks including functional blocks comprising devices, device components, steps or routines in a method embodied in software, or combinations of hardware and software.

Any of the steps, operations, functions, or processes described herein can be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions can be, for example, binaries, intermediate format instructions such as assembly language, firmware, or source code. Examples of computer-readable media that can be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter can have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

1. A radio equipment comprising:
memory having computer-readable instructions stored therein; and
one or more processors configured to execute the computer-readable instructions to:
receive at least one interference signal via an antenna of the radio;
determine one or more layers characteristics of one or network layers used for transmission of signals for the radio;
classify the interference signal using one or more features in the interference signal and the one or more layers characteristics; and
determine an interference mitigation scheme for countering the interference signal.

2. The radio equipment of claim 1, wherein the one or more processors are further configured to:
determine a feature matrix based on a combination of the one or more features and the one or more layers characteristics; and
classify the interference signal using the feature matrix.

3. The radio equipment of claim 2, wherein the one or more processors are configured to classify the interference signal using a trained neural network, the trained neural network being configured to receive the feature matrix as an input and provide a classification of the interference signal as an output.

4. The radio equipment of claim 1, wherein one or more processors are configured to determine the interference mitigation scheme using a trained neural network, the trained neural network being configured to receive the classified interference signal as an input and provide as output the interference mitigation scheme.

5. The radio equipment of claim 1, wherein the one or more processors are further configured to implement the interference mitigation scheme by modifying at least one parameter associated with signal transmission using the radio.

6. The radio equipment of claim 5, wherein the at least one parameter is a configuration of one or more network layers.

7. The radio equipment of claim 1, wherein the one or more network layers including a physical layer, a MAC layer and a network layer of a modem of the radio equipment.

8. One or more non-transitory computer-readable media comprising computer-readable instructions, which when executed by one or more processors of a radio equipment, cause the radio equipment to:
receive at least one interference signal via an antenna of the radio;
determine one or more layers characteristics of one or network layers used for transmission of signals for the radio;
classify the interference signal using one or more features in the interference signal and the one or more layers characteristics; and
determine an interference mitigation scheme for countering the interference signal.

9. The one or more non-transitory computer-readable media of claim 8, wherein the execution of the compute-readable instructions further causes the radio equipment to:
determine a feature matrix based on a combination of the one or more features and the one or more layers characteristics; and
classify the interference signal using the feature matrix.

10. The one or more non-transitory computer-readable media of claim 9, wherein the execution of the compute-readable instructions further cause the radio equipment to classify the interference signal using a trained neural network, the trained neural network being configured to receive the feature matrix as an input and provide a classification of the interference signal as an output.

11. The one or more non-transitory computer-readable media of claim 8, wherein the execution of the compute-readable instructions further causes the radio equipment to determine the interference mitigation scheme using a trained neural network, the trained neural network being configured to receive the classified interference signal as an input and provide as output the interference mitigation scheme.

12. The one or more non-transitory computer-readable media of claim 8, wherein the execution of the compute-readable instructions further causes the radio equipment to implement the interference mitigation scheme by modifying at least one parameter associated with signal transmission using the radio.

13. The one or more non-transitory computer-readable media of claim 12, wherein the at least one parameter is a configuration of one or more network layers.

14. The one or more non-transitory computer-readable media of claim 8, wherein the one or more network layers including a physical layer, a MAC layer and a network layer of a modem of the radio equipment.

15. A method comprising:
receiving, at a controller of a radio equipment, at least one interference signal via an antenna of the radio;
determining, by the controller, one or more layers characteristics of one or network layers used for transmission of signals for the radio;
classifying, by the controller, the interference signal using one or more features in the interference signal and the one or more layers characteristics; and
determining, by the controller, an interference mitigation scheme for countering the interference signal.

16. The method of claim 15, further comprising:
determining a feature matrix based on a combination of the one or more features and the one or more layers characteristics; and
classifying the interference signal using the feature matrix.

17. The method of claim 16, wherein the interference signal is classified using a trained neural network, the trained neural network being configured to receive the feature matrix as an input and provide a classification of the interference signal as an output.

18. The method of claim 15, wherein the interference mitigation scheme is determined using a trained neural network, the trained neural network being configured to receive the classified interference signal as an input and provide as output the interference mitigation scheme.

19. The method of claim 15, wherein the interference mitigation scheme is implemented by modifying at least one parameter associated with signal transmission using the radio.

20. The method of claim 15, wherein the at least one parameter is a configuration of one or more network layers.
